(19) United States
(12) Patent Application Publication
(10) Pub. No.: US 2026/0043434 A1
(43) Pub. Date: Feb. 12, 2026

(54) Fastener

(71) Applicant: Sentient Design, Inc., San Diego, CA (US)

(72) Inventor: Douglas Evan Hersh, San Diego, CA (US)

(21) Appl. No.: 19/359,658

(22) Filed: Oct. 15, 2025

Related U.S. Application Data
(63) Continuation-in-part of application No. 18/536,194, filed on Dec. 11, 2023.
Application No. 18/536,194 is a continuation of application No. 17/986,848, filed on Nov. 14, 2022, now Pat. No. 11,867,220.

(51) Int. Cl. F16B 39/26

(52) U.S. Cl. CPC F16B 39/26

(57) ABSTRACT

A nut-and-bolt fastener is provided. The nut and bolt are configured with a plurality of integrally formed spring tensioners. The spring tensioners are deflectable into channels to then exert a spring-bias force against workpiece members fastened between the nut and bolt. The spring-bias force increases the frictional force against mating teeth of the bolt and nut to lock the nut to the bolt and prevent disengagement of the fastener over time. The spring tensioners are employed in fasteners with helically threaded teeth providing bi-directional movement of the nut with respect to the bolt to increase preload and resist microslippage therebetween or in fasteners with non-helical, circumferential rings of teeth configured to provide unidirectional movement of the nut towards the bolt.

### CROSS-REFERENCE TO RELATED APPLICATIONS

This application is a continuation-in-part of U.S. patent application Ser. No. 18/536,194 entitled “Fastener” filed on Dec. 11, 2023 which is a continuation of U.S. patent application Ser. No. 17/986,848 entitled “Fastener” filed on Nov. 14, 2022, now U.S. Pat. No. 11,867,220 issued on Jan. 9, 2024, which is a continuation of U.S. patent application Ser. No. 16/537,322 entitled “Fastener” filed on Aug. 9, 2019 now U.S. Pat. No. 11,499,585 issued on Nov. 15, 2022, which claims priority and benefit of U.S. Provisional Patent Application Ser. No. 62/764,574 entitled “Rachet-toothed fastener” filed on Aug. 9, 2018, all of which are incorporated by reference in their entireties herein.

### FIELD OF THE INVENTION

This application relates generally to fasteners, and in particular, to nut-and-bolt-type fasteners.

### BACKGROUND OF THE INVENTION

Typical nut-and-bolt fasteners include a bolt having a helically threaded shank portion that threads together with a mating nut having a corresponding internal thread. The thread is a helical structure used to convert between rotational and linear movement or force. The screw thread is a ridge wrapped around the cylinder in the form of a helix. The cylinder may have a taper at the end in which case a tapered thread is formed as opposed to a straight thread on a cylinder without a taper. The mechanical advantage of a screw thread depends on its lead which is the linear distance the screw travels in one revolution. In most applications, the lead of a screw is chosen so that friction is sufficient to prevent linear forces being converted to rotary motion, that is so the screw does not slip even when linear force is applied as long as no external rotational force is present. The nut and bolt are kept together by a combination of the friction of their threads with a slight elastic deformation, a slight stretching of the bolt and compression of the parts held together between the nut and the bolt.

These typical nut-and-bolt fasteners have several disadvantages. For example, rotational movement is required to move the nut along the longitudinal axis of the bolt. To effect rotation, rotational force must be applied to rotate the nut relative to the bolt. This rotational force is supplied directly by hand or indirectly with a tool such as a driver or wrench. If the rotational force is applied with a tool, the tool must be appropriately sized and configured to engage with either the bolt or nut. For example, an appropriately sized wrench is employed to engage the hexagonal shape of the nut or head of the bolt. If the bolt is configured with a socket, an appropriately sized and shaped driver is required. In essence, different tools are required for different conventional bolts and nuts.

Furthermore, bolts of the different lengths must be stocked and employed for different applications because cutting a bolt to an appropriate length is costly, difficult and may damage the fastener. After a fastener and corresponding tool is selected, time must be taken to align the nut and bolt with each other so that they are not angled with respect to each other in order to prevent cross-threading. When rotational force is supplied to a nut or bolt, sometimes both the nut and bolt will rotate together due to higher rotational friction in threaded fasteners. In order to torque the nut with respect to the bolt, the bolt is kept stationary. This may require two tools to be employed. Furthermore, sufficient torque must be applied to tighten the nut and bolt. In some circumstances, it is not possible to completely rotationally tighten the fastener, for example, due to spatial limitations. Over-torquing and under-torquing can create problems. Also, applying torque in zero gravity such as outer space is nearly impossible without the source of torque, whether person or instrument, being strapped or connected in place to prevent counter rotation.

Furthermore, vibration or cyclic loading may loosen the nut relative to the bolt. Such loosening can cause the fastener to fall out or fail. A loosened or lost fastener can result in catastrophic damage and accidents to persons and equipment including automobiles, armatures, buildings and bridges. Missing or loose fasteners have been known to cause fatal airplane crashes. To prevent fasteners from loosening, various locking constructs and anti-backout mechanisms are needed as secondary means for keeping fasteners in place. The present invention as described in the detailed description sets forth an improved nut-and-bolt-type fastener that overcomes these disadvantages.

### SUMMARY OF THE INVENTION

According to one aspect of the invention, a fastener is provided. The fastener includes a bolt having a head at a proximal end and a shaft extending from an undersurface of the head to a distal end along a central longitudinal axis. The head has a diameter larger than the shaft. The head includes at least one deflectable spring tensioner integrally formed with the head and extending a distance beyond the undersurface toward the distal end when in an undeflected configuration. The fastener includes a nut defining a cylindrical bore extending through the nut along the longitudinal axis from a proximal end to a distal end of the nut. The bore and shaft are sized and configured such that the shaft is frictionally engaged within the bore and movable relative to the nut along the longitudinal axis. The nut includes at least one deflectable spring tensioner integrally formed with the nut and extending a distance beyond an undersurface of the nut when in an undeflected configuration. The spring tensioner on the head is configured to deflect away from the longitudinal axis towards a proximal end when in deflected configuration so as to reduce the distance the spring tensioner extends beyond the undersurface of the head. The spring tensioner on the nut is configured to deflect away from the longitudinal axis so as to reduce the distance the spring tensioner extends beyond the undersurface of the nut.

According to another aspect of the invention, a fastener is provided. The fastener includes a bolt having a head at a proximal end and a shaft extending from an undersurface of the head to a distal end along a longitudinal axis. The head has a diameter larger than the shaft. The fastener includes a nut defining a cylindrical bore extending through the nut along the longitudinal axis from a proximal end to a distal end of the nut. The bore and shaft are sized and configured such that the shaft is frictionally engaged within the bore and movable relative to the nut along the longitudinal axis. At least one of the head and the nut includes at least one integrally formed deflectable spring tensioner. The at least one spring tensioner is configured to contact a surface of one or more workpieces being fastened between the head and the nut when in an undeflected configuration and to flex against the workpiece surface into a deflected configuration away from the longitudinal axis when a longitudinal distance between nut and the head is reduced from the undeflected configuration.

### BRIEF DESCRIPTION OF THE DRAWINGS

FIG. 1 is a top perspective view of a fastener according to the present invention.

FIG. 2 is an exploded view of a fastener according to the present invention.

FIG. 3 is a side elevational view of a fastener according to the present invention.

FIG. 4 is a side elevational view of a fastener according to the present invention.

FIG. 5 is a top view of a fastener according to the present invention.

FIG. 6 is a bottom view of a fastener according to the present invention.

FIG. 7A is cross-sectional view taken along line 7A-7A of FIG. 5 of a fastener according to the present invention.

FIG. 7B is a cross-sectional view taken along line 7B-7B of FIG. 5 of a fastener according to the present invention.

FIG. 8 is a top perspective view of a nut according to the present invention.

FIG. 9 is a bottom perspective view of a nut according to the present invention.

FIG. 10 is a top view of a nut according to the present invention.

FIG. 11 is a bottom view of nut according to the present invention.

FIG. 12 is a side elevational view of a nut according to the present invention.

FIG. 13 is a cross-sectional view taken along line 13-13 of FIG. 12 of a nut according to the present invention.

FIG. 14 is a side elevational view of a nut according to the present invention.

FIG. 15 is a cross-sectional view taken along line 15-15 of FIG. 14 of a nut according to the present invention.

FIG. 16 is a sectional view of a fastener in an engaged configuration according to the present invention.

FIG. 17 is a sectional view of a fastener in a non-engaged configuration according to the present invention.

FIG. 18 is a cross-sectional view of a fastener according to the present invention.

FIG. 19 is a cross-sectional view of a nut according to the present invention

FIG. 20 is a sectional view of a fastener in an engaged configuration according to the present invention.

FIG. 21 is a sectional view of a fastener in a non-engaged configuration according to the present invention.

FIG. 22 is a top perspective view of a fastener according to the present invention.

FIG. 23 is a side-elevational of a fastener according to the present invention.

FIG. 24 is a cross-sectional view taken along line 24-24 of FIG. 23 of a fastener according to the present invention.

FIG. 25A is a top view of a fastener according to the present invention.

FIG. 25B is a bottom view of a fastener according to the present invention.

FIG. 26 is a cross-sectional view of a fastener according to the present invention.

FIG. 27 is a cross-sectional view of a fastener in an engaged configuration according to the present invention.

FIG. 28 is a cross-sectional view of a fastener in a non-engaged configuration according to the present invention.

FIG. 29 is a bottom perspective view of an expandable nut according to the present invention.

FIG. 30 is a top perspective view of an expandable nut according to the present invention.

FIG. 31 is a bottom view of an expandable nut according to the present invention.

FIG. 32 is a top view of an expandable nut according to the present invention.

FIG. 33 is a side view of an expandable nut according to the present invention.

FIG. 34 is a cross-sectional view taken along line 34-34 of FIG. 33 of an expandable nut according to the present invention.

FIG. 35 is a side-elevational view of an expandable nut according to the present invention.

FIG. 36 is a cross-sectional view taken along line 36-36 of FIG. 35 of an expandable nut according to the present invention.

FIG. 37 is a top perspective view of a fastener according to the present invention.

FIG. 38 is an exploded view of the fastener of FIG. 37.

FIG. 39 is a side elevational view of the fastener of FIG. 37.

FIG. 40 is a cross-sectional view of the fastener of FIG. 39.

FIG. 41 is a top view of the fastener of FIG. 37.

FIG. 42 is a bottom view of the fastener of FIG. 37.

FIG. 43 is a top perspective view of a nut of a fastener according to the present invention.

FIG. 44 is bottom perspective view of the nut of FIG. 43.

FIG. 45 is a side elevational view of the nut of FIG. 43.

FIG. 46 is a cross-sectional view of the fastener of FIG. 45.

FIGS. 47A-47C are cross-sectional, side elevational views of a fastener with spring tensioners in various degrees of deflection against two workpiece members according to the present invention.

FIGS. 48A-48C are cross-sectional, side elevational views of a nut with spring tensioners in various degrees of deflection according to the present invention.

FIGS. 49A-49C are side elevational views of a nut with spring tensioners in various degrees of deflection according to the present invention.

FIGS. 50A-50C are top perspective views of a nut with spring tensioners in various degrees of deflection according to the present invention.

### DETAILED DESCRIPTION OF THE INVENTION

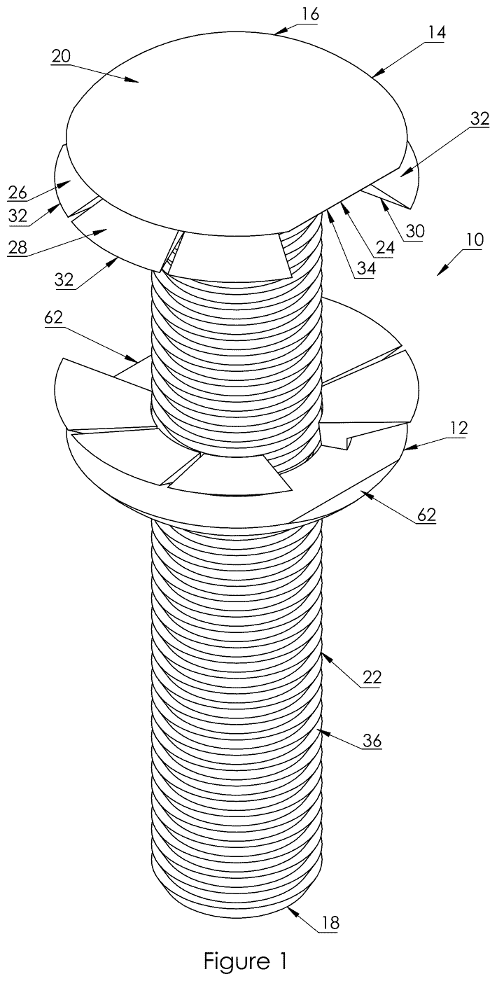

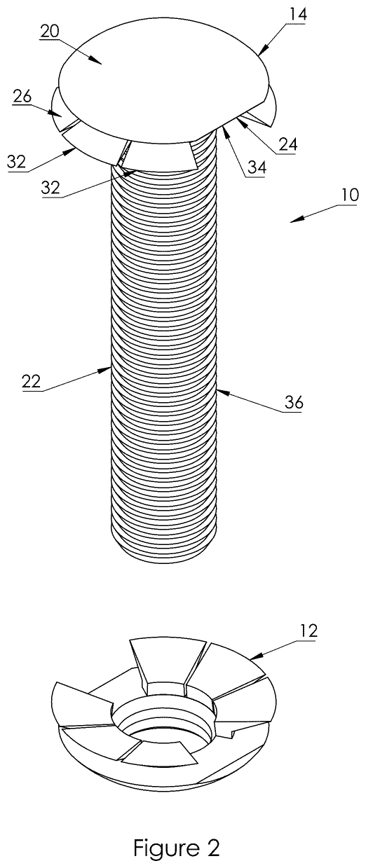

FIGS. 1-10 depict a fastener 10 according to one variation of the invention. The fastener 10 comprises a first part connectable to a second part and configured to fasten together one or more objects therebetween. The first part and the second part of the fastener 10 take the form of a nut 12 and a bolt 14. The bolt 14 comprises an elongate body extending between a proximal end 16 and a distal end 18 along a central longitudinal axis. The elongate body is divided into two sections: a head 20 at the proximal end connected to a cylindrical shank 22 extending to the distal end 18.

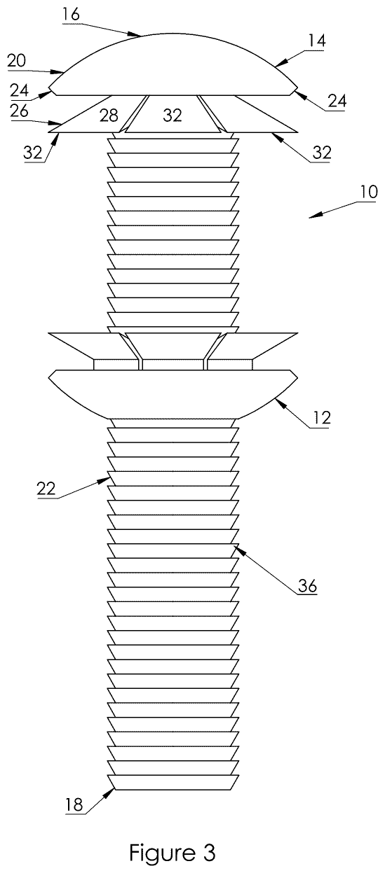

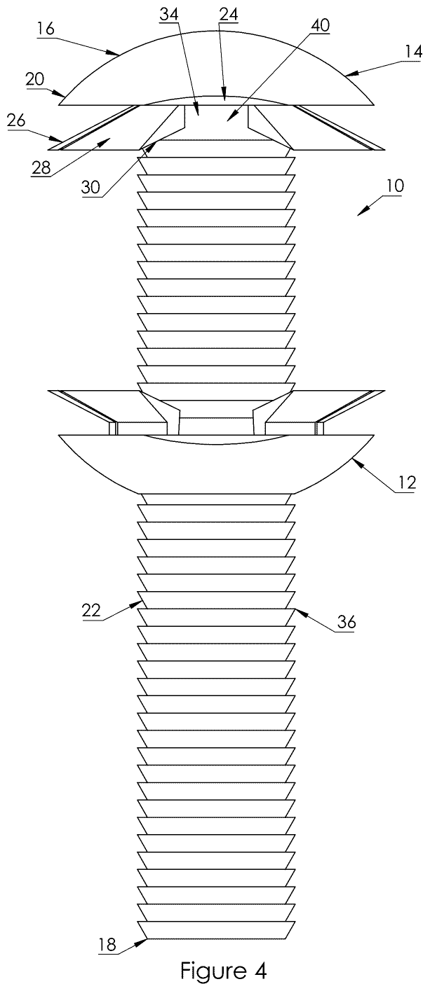

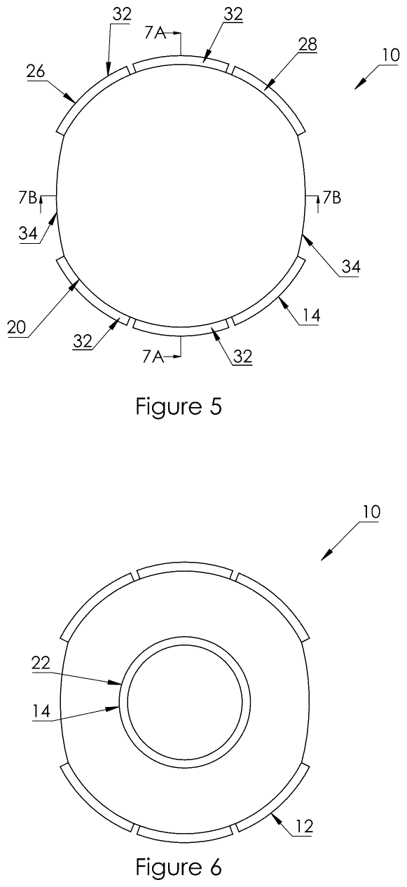

The head 20 at the proximal end 16 defines a workable end that is adapted to be worked or gripped by a hand, power tool or robot for handling and manipulating the bolt 14. The head 20 has a diameter larger than the diameter of the shank 22. The head 20 has a domed top surface and a flat undersurface meeting at a tapered perimeter as can be seen in FIGS. 3-4. The head 20 is circular in shape. In another variation, the head 20 is elongated or elliptical in shape as can be seen in FIGS. 5-6. Each of the oppositely disposed longer sides of the elongated head 20 include a flat surface or chamfer 24. The elongated shape and chamfers 24 of the head 20 will be discussed in greater detail below. Advantageously, the domed surface of the head 20 does not have any socket or outer surface configured for engaging an instrument to drive the bolt 14.

In one variation, the head 20 includes a washer 26 integrally formed with the bolt 14 as a unitary element. The integral washer 26 advantageously avoids loose separate parts and their assembly on site. The washer 26 has an upper surface 28 and a lower surface 30 meeting at a tapered outer perimeter. The washer 26 substantially encompasses the cylindrical shank 22. In one variation, the upper surface 28 and lower surface 30 are angled downwardly to create a truncated conical lower surface 30. The lower surface 30 of the disc-like washer 26 is slightly conical, concave, angled, curved, cone-shaped, spherical, domed or cupped. Because of the shape of the lower surface 30, the washer 26 is functionable as a spring washer or conical washer which advantageously provides an axial force when deformed under compression. The conical shell of the washer 26 can be loaded in the longitudinal direction and the force transmission is generally concentric. In one variation, the washer 26 of the present invention is provided with a plurality of radial serrations dividing the washer 26 into segments or wings 30. There is an absence of one or more segment/wing 30 in opposite locations on the washer 26 forming openings 34 between the wings 30 for accessing the shank 22 which will be described in greater detail below. In the variation in which the head 20 is elongated, the openings 34 are located along the long sides of the head 20 as can be seen in FIG. 5. The washer 26 including one or more of the wings 30 either together or independently are configured to flex, bend, deflect, deform upwardly towards the head 20 and provide a spring force in the opposite axial direction against a fastened object to improve the locking capabilities of the fastener. Unless plastically deformed, the washer 26 will return to its original undeflected configuration. The individual wings 30 can flex independently and, thereby, more closely conform to a non-smooth, irregular surface.

The shank 22 now will be described in greater detail. The shank or shaft 22 includes a toothed portion 36 having a plurality of teeth 38 along the length of the shank 22. In one variation, the shank 22 has a body portion 40 without teeth 38 located between the toothed portion 36 and the head 20 as can be seen in FIG. 4. In one variation, the body portion 40 is cylindrical; however, the invention is not so limited, and the body portion may include flat surfaces or have a non-circular cross-sectional shape.

Each tooth 38 is formed circumferentially around the shank 22 at a constant distance along the longitudinal axis. Therefore, the toothed portion 36 is not threaded as there is no helical shape formed in the teeth. The lead of a threaded shaft is known to be the distance along the longitudinal axis that a threaded nut travels on the threads of a bolt in one revolution of the nut around the longitudinal axis of the bolt with rotation of the nut being about the longitudinal axis. Because the shaft 22 lacks helical threads in the present invention, the lead is zero, meaning a revolution of the nut 12 around the shaft 22 produces no axial translation. As such, each tooth 38 is a separate circular, annular, non-helical groove or ring interconnected with itself around the cylindrical shank 22 and a plurality of evenly separated grooves or steps are formed along the length of the longitudinal axis in the toothed portion 36 with each groove lying in separate parallel planes all of which are perpendicular and concentric to the longitudinal axis and annular wherein the distance between adjacent parallel planes is called the pitch in the present invention. There are approximately 20-120 teeth per inch along the longitudinal axis.

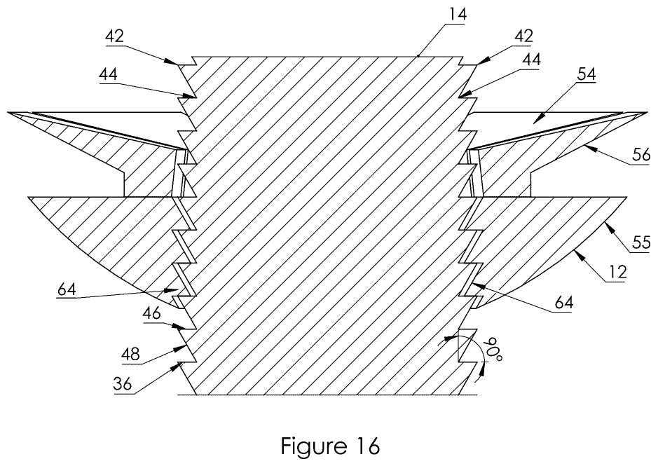

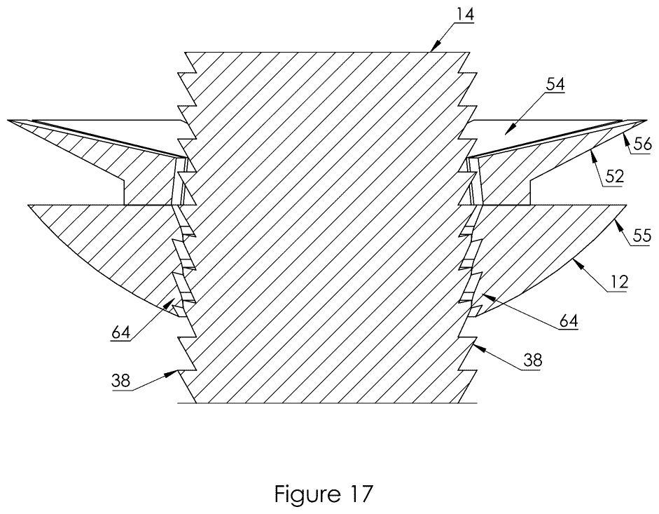

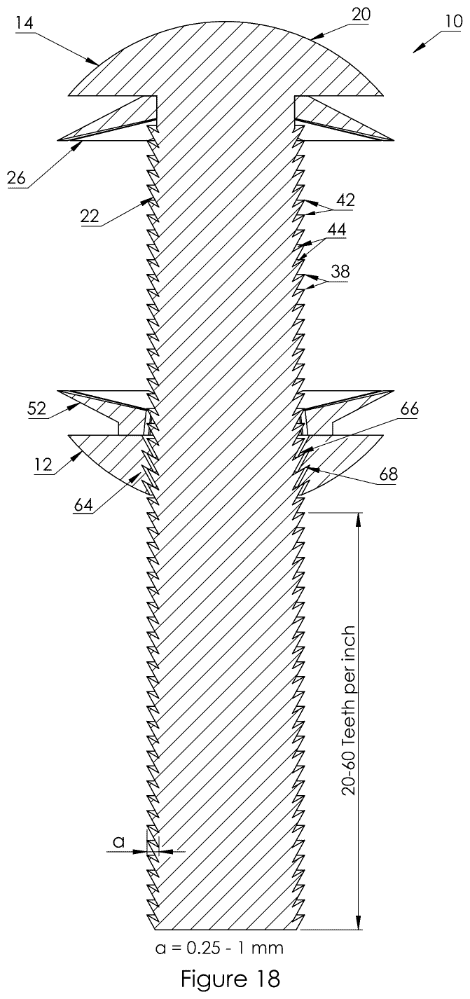

With particular reference to FIGS. 16 and 17, each tooth 38 defines a tip 42 and a root 44 with each point on a tooth 38 lying in the same plane perpendicular to the longitudinal axis. For example, all the points comprising the tip 42 of a single tooth 38 lie in a single plane perpendicular to the longitudinal axis. Likewise, all of the points comprising the root 44 of a single tooth 38 lie in a single plane perpendicular to the longitudinal axis. An outer diameter is defined as the tip-to-tip 42-42 distance across the shank 22 of a single tooth 38. An inner diameter is defined as the root-to-root 44-44 distance across the shank 22 of a single tooth 38. The outer diameter is larger than the inner diameter. The height of a tooth 38 is defined as the outer diameter minus the inner diameter divided by two. The height is approximately 0.10-1.00 millimeters in length. Each tooth 38 has a load-bearing face or step 46 and a ramped face 48 interconnected at a tip 42 or root 44. The load-bearing face 36 has a much steeper slope relative to the ramped face 48 which has a more moderate slope. The load-bearing face 46 is perpendicular to the central longitudinal axis. Both the load-bearing face 46 and the ramped face 48 form a triangular-shaped tooth that extends outwardly from the inner diameter and is formed around the cylindrical surface of the shaft. In cross-section, each tooth 38 forms a scalene triangle in which the two sides of the triangle are of unequal length with the ramped face 48 being longer than the load-bearing face 46. The angle between the load-bearing face 46 and the ramped face 48 is approximately 60 degrees. The root 44 and the tip 42 are, preferably, not truncated or rounded to provide the largest surface contact in order to withstand larger axial forces.

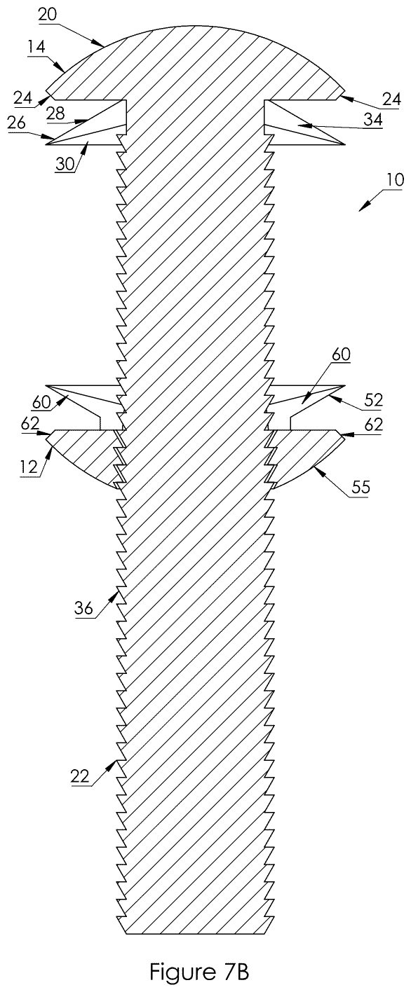

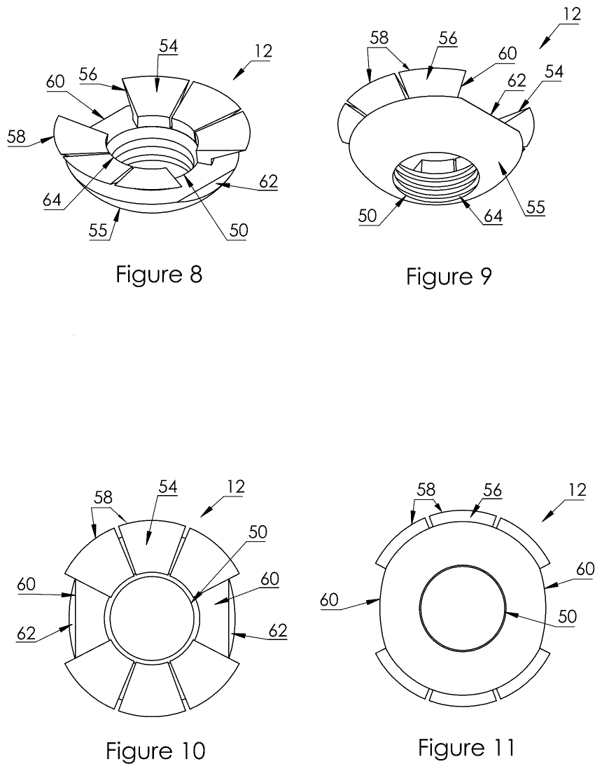

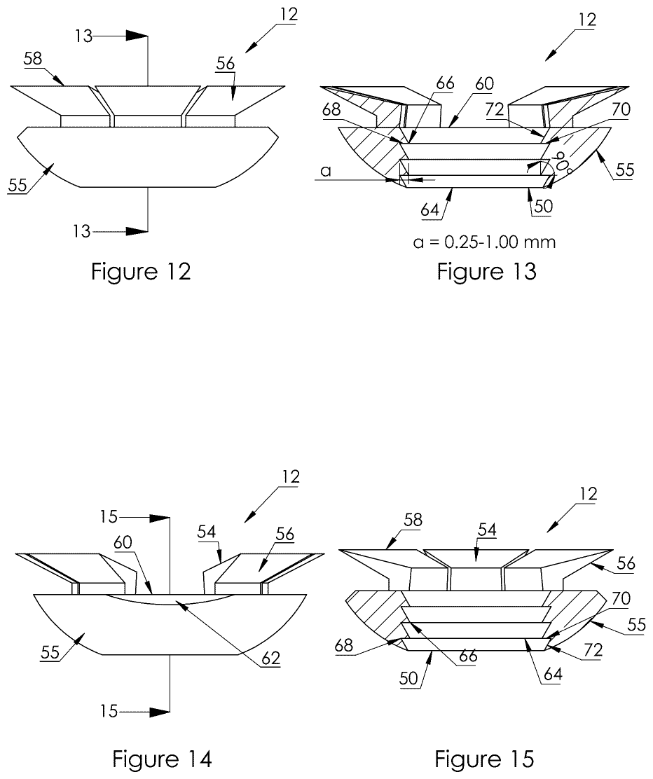

Turning now to FIGS. 8-15, the nut 12 according to the present invention will be discussed. The nut 12 includes a central bore 50 extending between a proximal end and a distal end of the nut 12 along the longitudinal axis. The bore 50 is cylindrical in shape and sized and configured to receive the shank 22 of the bolt 14. The distal end of the nut 12 forms a curved or dome-shaped head 55. Advantageously, the domed surface of the head 55 does not have any socket or outer surface configured for engaging an instrument to drive the nut 12. The proximal end of the nut 12 includes a washer 52. The washer 52 is integrally formed with the nut 12 as a unitary element which advantageously avoids loose and separate parts. The washer 52 includes an upper surface 54 and a lower surface 56 meeting at a tapered outer perimeter. The washer 52 substantially surrounds the central bore 50. In one variation, the upper surface 54 and lower surface 56 are angled upwardly to create a truncated conical upper surface 54. The upper surface 54 of the disc-like washer 52 is slightly conical, concave, angled, curved, cone-shaped, spherical, domed or cupped. Because of the shape of the upper surface 54, the washer 52 is functionable as a spring washer or conical washer which advantageously provides an axial force when deformed under compression. The conical shell of the washer 52 can be loaded in the longitudinal direction and the force transmission is generally concentric. In one variation, the washer 52 of the present invention is provided with a plurality of radial serrations dividing the washer 52 into segments or wings 58. There is an absence of one or more segment/wing 58 in opposite locations on the washer 52 forming openings 60 between the wings 58 for accessing the bore 50 which will be described in greater detail below. In one variation, the head 55 is elongated and the openings 60 are located along the long sides of the head 55 as can be seen in FIGS. 10-11. The washer 52 including one or more of the wings 58 either together or independently are configured to flex, deflect, bend, deform downwardly towards the head 50 and provide a spring force in the opposite axial direction against a fastened object to improve the locking capabilities of the fastener against the object. Unless plastically deformed, the washer 52 will return to its original undeflected configuration. The individual wings 58 can flex independently and, thereby, the upper surface 54 can more closely conform to a non-smooth, irregular surface of a fastened object. The washer 50 is substantially the same as the washer 26 on the bolt 14. The head 55 includes oppositely disposed, angled chamfers 62 in the location of the openings 60 to improve accessibility to the bore 50 via the openings 60.

The internal surface of the bore 50 of the nut 12 is provided with a plurality of ridges 64 formed along the length of the bore 50. The ridges 64 are sized and configured to conform and mate with the teeth 38 formed on the shank 22 in an interlocking manner. Each ridge 64 is formed circumferentially around the bore 50 at a constant distance along the longitudinal axis of the nut 12. The bore 50 is not threaded as there is no helical shape formed by the ridges 38. As previously mentioned, since there are no helical threads formed inside the nut 12, the lead is zero, that is, a revolution of the nut 12 of the present invention with respect to the bolt 14 around the longitudinal axis does not translate the nut 12 along the longitudinal axis. As such, each ridge 64 is a separate circular, annular, non-helical groove, step or ring interconnected with itself around the inside surface of the bore 50. A plurality of equally spaced grooves or steps is formed along the length of the bore 50 with each groove lying in separate parallel planes all of which are perpendicular and concentric to the longitudinal axis wherein the distance between adjacent parallel planes is called the pitch in the present invention. There are approximately 20-120 teeth per inch along the longitudinal axis. The length of the nut 12 and the number of ridges 64 is configured to provide sufficient locking strength to the nut 12. A greater number of ridges 64 on a nut 12 will provide greater locking strength between the nut and the bolt and the nut will be able to withstand larger axial loads. Also, a greater number of ridges along a correspondingly longer nut, will require greater force to move the nut along the bolt. Hence, the number of ridges in the nut and the corresponding length of the nut is selected for a given application as needed to withstand the required amount of axial load in the distal direction to lock the nut with the nut still being movable on the bolt in the proximal direction without undue force. In one variation, there are approximately 4-6 ridges 64 in a nut 12. In another variation, there are at least 4 ridges 64. In another variation, there are 4-10 ridges and, in another variation, there are at least 3 ridges.

With particular reference to FIGS. 13 and 15, each ridge 64 defines a tip 66 and a root 68 with each point on a ridge 64 lying in the same plane that is perpendicular to the longitudinal axis. For example, all the points comprising the tip 66 of a single ridge 64 lie in a single plane perpendicular to the longitudinal axis. Likewise, all of the points comprising the root 68 of a single ridge 64 lie in a single plane perpendicular to the longitudinal axis. An outer diameter of the bore 50 is defined as the root-to-root 68-68 distance across the bore 50 of a single ridge 64. An inner diameter of the bore 50 is defined as the tip-to-tip 66-66 distance across the bore 50 of a single ridge 64. The outer diameter of the bore 50 is larger than the inner diameter. The height of a ridge 64 is defined as the outer diameter minus the inner diameter divided by two. The height is approximately 0.10-1.00 millimeters in length. Each ridge 64 has a load-bearing face 70 and a ramped face 72 interconnected at a tip 66 or root 68. The load-bearing face 70 has a much steeper slope relative to the ramped face 72 which has a more moderate slope. The load-bearing face 70 is perpendicular to the central longitudinal axis. Both the load-bearing face 70 and the ramped face 72 form a triangle-shaped ridge 64 that extends outwardly from the outer diameter of the bore 50 and toward the central longitudinal axis and is formed around the cylindrical surface of the bore 50. In cross-section, each ridge 64 forms a scalene triangle in which the two sides of the triangle are of unequal length. The angle between the load-bearing face 70 and the ramped face 72 is approximately 60 degrees. The root 68 and the tip 66 are, preferably, not truncated or rounded to provide the largest surface contact possible for withstanding larger axial forces. The bore 50 is provided with an equal number of ridges 64 per inch as is provided on the bolt 14 and the triangular shape of the ridges 64 are the same as the triangular shape of the teeth 38.

The bolt 14 is sized and configured to fit inside the bore 50 of the nut 12 with interference between the circumferential teeth 38 on the bolt 14 and the circumferential ridges 64 on the surface of the bore 50 of the nut 12. As such, the inner diameter of the bore 50 is larger than the inner diameter of the shank 22. Also, the inner diameter of the bore is smaller than the outer diameter of shank 22. The outer diameter of the bore 50 is larger than the outer diameter of the shank 22. The interference between the ridges 64 on the bore 50 and the teeth 38 on the shank 22 is configured such that the ridges 64 interlock with the teeth 38 to fix the longitudinal position of the nut 12 relative to the bolt 14 with respect to translation of the nut 12 in the distal direction.

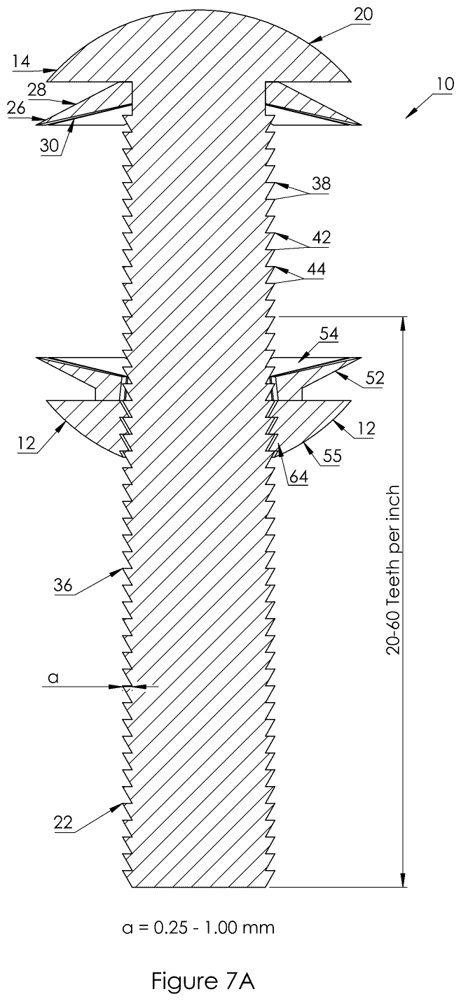

The fastener system 10 according to the present invention defines an engaged configuration depicted in FIGS. 7A-7B and 16 in which the teeth 38 are interlocked with the ridges 64. In particular, the load-bearing face 46 of the teeth 38 abut, contact, face, and are substantially parallel to the load-bearing face 70 of the ridges 64 and translation of the nut 12 relative to bolt 14 in a distal direction away from the head 20 of the bolt 14 is arrested. In this engaged configuration, one or more of the ridges 64 of the nut 12 are engaged/interlocked with an equal number of teeth 38 on the bolt 14. If the entire nut 12 is located proximal to the distal end 18 of the bolt 14, all of the ridges 64 are interlocked, engaged with an equal number of teeth 38 on the bolt 14. When in the engaged configuration, movement of the nut 12 relative to the bolt 14 in a distal direction is prevented by the abutment of the load-bearing faces 46, 70; however, translation of the nut 12 relative to the bolt 14 in a proximal direction toward the head 20 is permitted as the ramped surfaces 48, 72 are permitted to slide relative to each other due to their moderate slope, angle. Hence, the fastener 10 of the present invention is a unidirectional fastener, permitting translation of the nut 12 relative to the bolt 14 in only one direction, that being in the proximal direction toward the head 20 of the bolt 14 in order to reduce the distance between the nut 12 and the head 20 of the bolt 14 and fasten against an object captured therebetween. The unidirectional fastener of the present invention does not permit translation of the nut 12 relative to the bolt 14 distally toward the distal end 18 of the bolt 14.

The fastener system 10 according to the present invention defines a non-engaged configuration depicted in FIG. 17 in which the teeth 38 are not interlocked with the ridges 64. In particular, when the nut 14 is translating with the shank 22 inside the bore 50, the ramped surface 72 of each ridge 64 will slide against the ramped surface 48 of each tooth 38 forcing the ridges 64 and teeth 38 to deflect against each other. Such deflection takes place close to the tips 42, 66 where the material comprising the teeth 38 and ridges 64 is thinner and more flexible. FIG. 17 depicts the non-engaged configuration in which the teeth 38 and ridges 64 are oppositely deflected. When the tips 66 of the ridges 64 substantially simultaneously ramp over the tips 42 of the teeth 38 the deflected tips 42, 66 will simultaneously spring back toward their original undeflected configuration and snap into position of the engaged configuration. The nut 12 may continue to be moved proximally but is not permitted to be moved in a distal direction. Because of the moderate slope of the ramped surfaces 48, 72, there is less friction between the nut 12 and bolt 14 with movement in the proximal direction. When moving in an unrestricted direction, i.e. proximally toward the head 20 of the bolt 14, the nut 12 easily slides along the shank 22 with an audible click when the ridges 64 snap into position between teeth 38. When the nut 12 is attempted to be moved in the distal direction away from the head 20 of the bolt 14, the load-bearing surfaces 46,70 will abut and the ridges 64 will lock against the teeth 38 preventing any further motion in that direction. Relative rotational movement of the nut 12 around the bolt 14 does not result in translation of the nut 12 in along the longitudinal axis. There is little rotational friction and the nut may freely rotate around the bolt without affecting the fixed relationship in the longitudinal direction.

In use, the bolt 14 is passed through one or more target objects to be fastened together. The bolt 14 is inserted into the bore 50 of the nut 12 in the proper orientation with the washer 52 facing the target objects. The nut 12 is moved toward the head 20 of the bolt 14 and the barb-like circumferential teeth 38 are deflected simultaneously with engagement of the barb-like ridges 68 as the ramped surfaces 48, 72 slide against each. The teeth 38 are deflected proximally with proximal movement of the nut 12 relative to the bolt 14 and the ridges 64 are deflected distally. After the ridges 64 clear the teeth 38, the ridges 64 enter into complementary engagement wherein the ridges 64 are located between adjacent teeth 38 and the load-bearing surfaces 46, 70 and ramped surfaces 48, 72 facing each other. The teeth 38 and ridges 64 both elastically deform. In one variation, only the teeth 38 elastically deform and the ridges 64 are not elastically deformed and merely ride over the teeth 38. In another variation, only the ridges 64 elastically deform and the teeth 38 are not elastically deformed. In yet another variation, both the teeth 38 and ridges 64 do not elastically deform. Movement of the nut 12 toward the distal end of the bolt 14 is arrested as the load-bearing surfaces 46, 70 abut; however, continued proximal movement of the nut 12 relative to the bolt 14 is permitted to continue until the washer 26 on the bolt 14 and the washer 52 on the nut 12 contact the target objects therebetween. With continued movement of the nut 12 towards the proximal end, both washers 26, 52 will begin to deflect causing the conical-shaped washers to flatten against the surface of the target objects. The segments 32, 58 will flex independently of each other and conform against an irregular surface. With continued compression of the washers, a spring force in the opposite axial direction will be exerted forcing the head 55 of the nut 12 distally and increasing the friction against the load-bearing surfaces 46, 70 locking the nut 12 tightly to the bolt 14 and against the target objects. The bolt and nut washers 26, 52 tension the fastener by applying simultaneously opposing forces. Movement of the nut 14 toward the distal end 18 is prevented and the locked nut cannot be released and the space between the nut 14 and the head 20 cannot be increased. Only unidirectional translation of the nut 14 relative to the bolt 12 is possible.

If it is desired to remove the fastener or unlock the nut from the bolt, it is necessary to cut or break the bolt or nut. The fastener 10 can be made from any suitable material including metal or plastic or a combination of metal and plastic such as the nut being made of plastic and the bolt made of metal or vice versa. The fastener 10 can be made of plastic or other polymer such as polypropylene and nylon or other frangible material that lends itself to be cut or destroyed. The fastener 10 can be a single use fastener or a reusable fastener. The fastener of the present invention continues to function even when the ridges or teeth have been worn down. In one variation, the bolt is manufactured without a head to permit removal of the fastener without cutting it. The fastener 10 can be manufactured in any number of ways known in the art including injection molding enabling them to be less costly than conventional metal fasteners and lighter in weight. Weight-to-strength ratios are crucial in many fastener applications.

A suitable cutting instrument such as nipper dikes can be employed to release the fastener 10. The cutting jaws of the instrument are aligned with the oppositely disposed chamfers 24 on the bolt head 20 and the oppositely disposed openings 34 formed in the washer 26. The openings 34 advantageously expose the shaft of the bolt 14 to be cut and provide a location unobstructed by the domed head 20, or washer 26 as well as a location where there is less thickness of material to facilitate cutting of the shank 22. The chamfers 24 assist in leading an instrument into position. After the cutting instrument is activated, the large diameter head and washer 26 is removed from the shank 22. The washer 26 is configured such that the individual segments 32 are easily removed when a cut is made at the oppositely disposed openings 34. With the washer 26 and head 20 removed, the target objects can be removed and/or the nut 12 moved in the proximal direction toward the cut location and off the shank 22. Alternatively, or in conjunction with cutting the proximal end of the bolt 14, a cut using the same instrument can be made at the location of the nut 14. In particular, the jaws of the cutting instrument are aligned with the openings 60 at the washer 52 on the nut 12. The instrument is activated and the nut 12 and shank 22 are cut at a location above the ridges 64. The segments 58 of the washer 52 advantageously fall away and the fastener can be freely removed. The fastener 10 of the present invention advantageously cannot be released by twisting or rotating the nut 12 in the opposite direction as in a common nut-and-bolt fastener with helical threads. These conventional nut-and-bolt fasteners are loosened when subjected to continued vibration which is advantageously not possible with the fastener of the present invention. Because the fastener 10 can be easily cut, the present invention avoids the need for stocking multiple bolts having different lengths for different applications. The cutting instrument used to release the fastener can also be used to advantageously cut the bolt to length as desired. Cutting a conventional bolt with helical threads to length is difficult as threads can be easily damaged during the process preventing threaded engagement.

Turning now to FIGS. 18-21, another variation of the fastener 10 will be described wherein like reference numbers are used to describe like parts. In the variation of FIGS. 18-21, the fastener 10 is the same as the fastener 10 of FIGS. 1-17 except for the triangular shape of the teeth 38 and ridges 64.

In the variation of FIGS. 18-21, an outer diameter is defined as the tip-to-tip 42-42 distance across the shank 22 of a single tooth 38. An inner diameter is defined as the root-to-root 44-44 distance across the shank 22 of a single tooth 38. The outer diameter is larger than the inner diameter. The height of a tooth 38 is defined as the outer diameter minus the inner diameter divided by two. The height for the variation of FIGS. 18-21 is approximately 0.10-1.00 millimeters in length. The load-bearing face 46 is raked/angled toward the proximal end. Both the load-bearing face 46 and the ramped face 48 form a triangular-shaped tooth that extends outwardly from the inner diameter and is formed around the cylindrical surface of the shaft. In cross-section, each tooth 38 forms a scalene triangle in which the two sides of the triangle are of unequal length with the ramped face 48 being longer than the load-bearing face 46. The angle between the load-bearing face 46 and the ramped face 48 is approximately 30 degrees. In another variation the angle between the load-bearing face 46 and the ramped face 48 is between zero degrees and approximately 60 degrees. In another variation, the angle between the load-bearing face 46 and longitudinal axis is between 0 and 90 degrees. The root 44 and the tip 42 are, preferably, not truncated or rounded to provide the largest surface contact in order to withstand larger axial forces. The smaller angle of 30 degrees between the load-bearing face 46 and the ramped face 48 makes the tip 42 more flexible compared with the variation of FIGS. 1-17. Also, the load-bearing face 46 is slightly longer relative to the load-bearing face 46 of the variation of FIGS. 1-17.

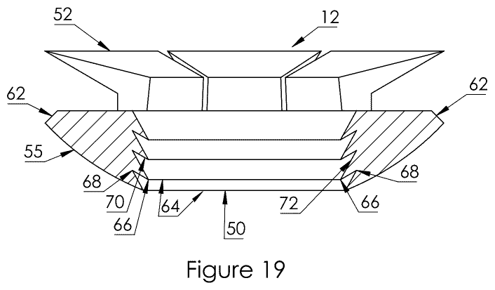

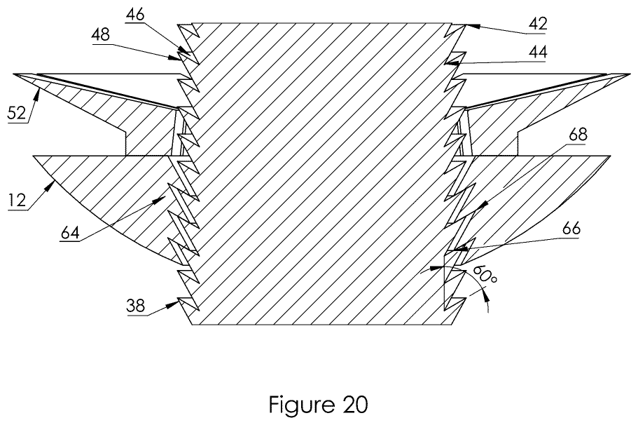

With particular reference to FIG. 19, the nut 12 includes ridges 64 that are sized and configured and complementarily raked/angled to engage and interlock with the teeth 38 of the bolt 14. The outer diameter of the bore 50 is defined as the root-to-root 68-68 distance across the bore 50 of a single ridge 64. An inner diameter of the bore 50 is defined as the tip-to-tip 66-66 distance across the bore 50 of a single ridge 64. The outer diameter of the bore 50 is larger than the inner diameter. The height of a ridge 64 is defined as the outer diameter minus the inner diameter divided by two. The height is approximately 0.10-1.00 millimeters in length for the variation in FIGS. 18-21. Each ridge 64 has a load-bearing face 70 and a ramped face 72 interconnected at a tip 66 or a root 68. The load-bearing face 70 has a much steeper slope relative to the ramped face 72 which has a more moderate slope. The load-bearing face 70 is inclined with respect to the central longitudinal axis. Both the load-bearing face 70 and the ramped face 72 form a triangle-shaped ridge 64 that extends outwardly from the outer diameter of the bore 50 and toward the central longitudinal axis and is formed around the cylindrical surface of the bore 50. In cross-section, each ridge 64 forms a scalene triangle in which the two sides of the triangle are of unequal length with the ramped face 72 being longer than the load-bearing face 70. The angle between the load-bearing face 70 and the ramped face 72 is approximately 30 degrees. In another variation the angle between the load-bearing face 70 and the ramped face 72 is between zero degrees and approximately 60 degrees. In another variation, the angle between the load-bearing face 70 and longitudinal axis is between 0 and 90 degrees. The root 68 and the tip 66 are, preferably, not truncated or rounded to provide the largest surface contact possible for withstanding larger axial forces. The bore 50 is provided with an equal number of ridges 64 per inch as is provided on the bolt 14. The smaller angle of 30 degrees between the load-bearing face 70 and the ramped face 72 makes the tip 66 more flexible compared with the variation of FIGS. 1-17. Also, the load-bearing face 70 is slightly longer relative to the load-bearing face 70 of the variation of FIGS. 1-17. The ridges 64 fit between the teeth 38 as shown in FIG. 20 with a small acceptable manufacturing tolerance.

The engaged or locked configuration depicted is depicted in FIGS. 18 and 20 in which the teeth 38 are interlocked with the ridges 64. In particular, the load-bearing face 46 of the teeth 38 abut, contact, face, and are substantially parallel to the load-bearing face 70 of the ridges 64 and translation of the nut 12 relative to bolt 14 in a distal direction away from the head 20 of the bolt 14 is arrested. In this engaged configuration, one or more of the ridges 64 of the nut 12 are engaged/interlocked with an equal number of teeth 38 on the bolt 14. If the entire nut 12 is located proximal to the distal end 18 of the bolt 14, all of the ridges 64 are interlocked, engaged with an equal number of teeth 38 on the bolt 14. When in the engaged configuration, movement of the nut 12 relative to the bolt 14 in a distal direction is prevented by the abutment of the load-bearing faces 46, 70; however, translation of the nut 12 relative to the bolt 14 is a proximal direction toward the head 20 is permitted as the ramped surfaces 48, 72 are permitted to slide relative to each other due to their moderate slope, angle. Hence, the fastener 10 of the present invention is a unidirectional fastener, permitting translation of the nut 12 relative to the bolt 14 in only one direction, that being in the proximal direction toward the head 20 of the bolt 14 in order to reduce the distance between the nut 12 and the head 20 of the bolt 14, capturing therebetween the objects targeted for fastening. The unidirectional fastener of the present invention does not permit movement of the nut 12 relative to the bolt 14 distally toward the distal end 18 of the bolt 14.

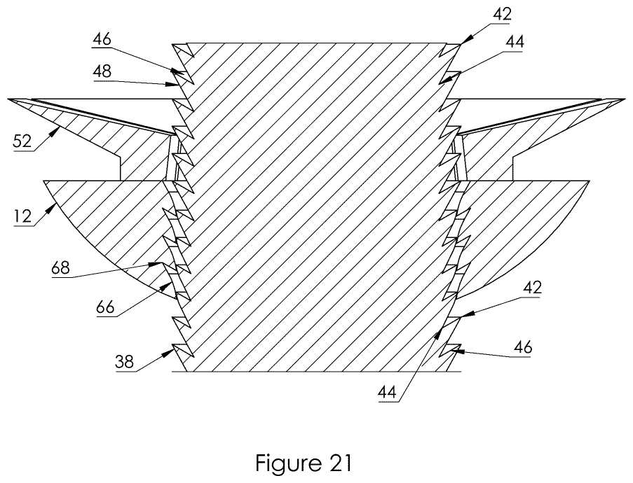

The non-engaged configuration is depicted in FIG. 21 in which the teeth 38 are not interlocked with the ridges 64. In particular, when the nut 14 is translating with the shank 22 inside the bore 50, the ramped surface 72 of each ridge 64 will slide against the ramped surface 48 of each tooth 38 forcing the ridges 64 and teeth 38 to deflect against each other. Such deflection takes place close to the tips 42, 66 where the material comprising the teeth 38 and ridges 64 is thinner and more flexible. FIG. 21 depicts the non-engaged configuration in which the teeth 38 and ridges 64 are deflected. When the tips 66 of the ridges 64 simultaneously ramp over the tips 42 of the teeth 38 the deflected tips 42, 66 will simultaneously spring back toward their original undeflected configuration and snap into position of the engaged configuration. The nut 12 may continue to move proximally but is prevented from moving distally. Because of the moderate slope of the ramped surfaces 48, 72, there is less friction between the nut 12 and bolt 14 with movement in the proximal direction. When moving in an unrestricted direction, i.e. proximally toward the head 20 of the bolt 14, the nut 12 easily slides along the shank 22 with an audible click when the ridges 64 snap into position between the teeth 38. When the nut 12 is attempted to be moved in the distal direction away from the head 20 of the bolt 14, the load-bearing surfaces 46, 70 will abut and the ridges 64 will lock against the teeth 38 preventing any further motion in that direction. Relative rotational movement of the nut 12 around the bolt 14 does not result in translation of the nut 12 along the longitudinal axis. There is little rotational friction and the nut may freely rotate around the bolt without affecting the fixed relationship in the longitudinal direction.

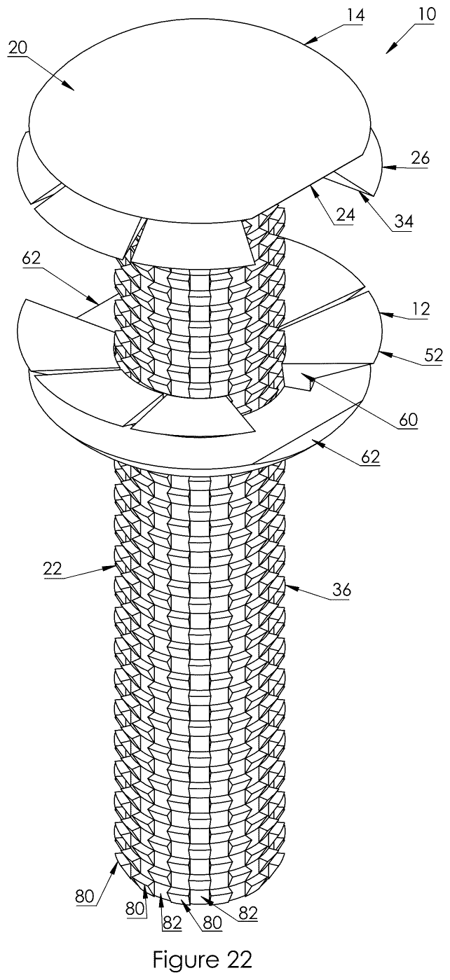

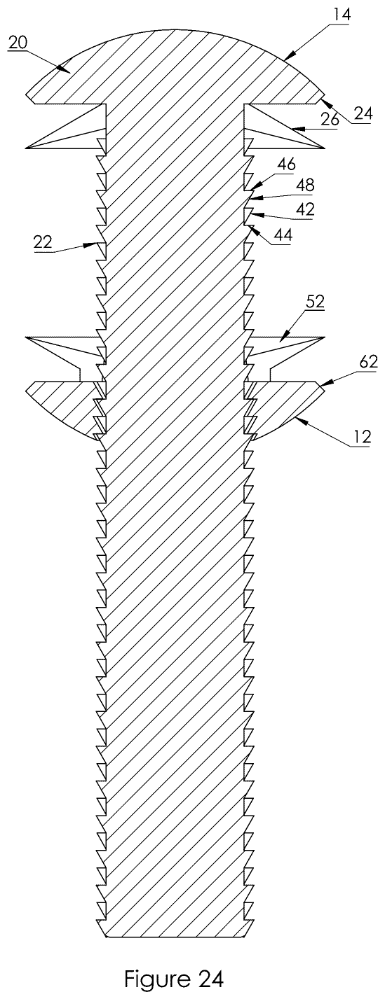

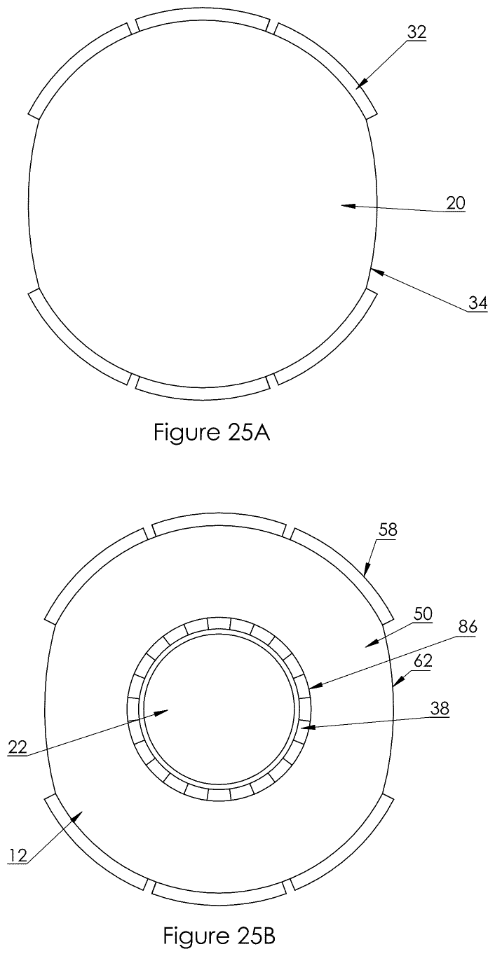

Turning now to FIGS. 22-28, another variation of the fastener 10 will be described wherein like reference numbers are used to describe like parts. In the variation of FIGS. 22-28, the fastener 10 is the same as the fastener 10 of FIGS. 1-17 except for the arrangement and configuration of teeth 38 on the bolt 14 and ridges 64 on the nut 12. The head 20 and washer 26 of the bolt 14 as well as the head 55 and washer 52 of the nut 12 are the same as in FIGS. 1-17. Therefore, the arrangement of teeth 38 and the ridges 64 will be described for this variation.

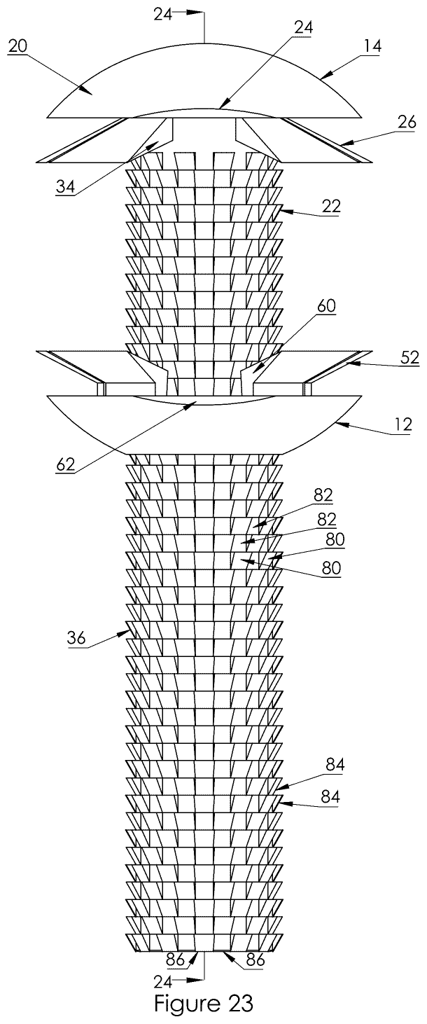

With particular reference to FIGS. 22 and 23 the toothed portion 36 of the shaft 22 is provided with a plurality of individual, wedge-like teeth 38 arranged evenly in rows 84 and columns 86 forming toothed segments 80 around the cylindrical shank 22 and extending outwardly from the inner diameter. The toothed segments 80 are interspersed with blank segments 82 without teeth 38 in a checkerboard-like fashion wherein in any given circumferential row 84 or longitudinal column 86, toothed segments 80 alternate with blank segments 82. The segments 80, 82 are of equal shape and size. The segments 80, 82 are square in one variation and rectangular in another variation. In one variation, there are 24 segments in each circumferential row 84 comprising twelve toothed segments 80 located alternatingly between twelve blank segments 82. Each toothed segment 80 is an arc of approximately 15 degrees. There are approximately 20-120 rows of teeth 38 per inch along the longitudinal axis.

In the variation of FIGS. 22-28, an outer diameter is defined as the tip-to-tip 42-42 distance across the shank 22 of a single tooth 38. An inner diameter is defined as the root-to-root 44-44 distance across the shank 22 of a single tooth 38. The outer diameter is larger than the inner diameter. The height of a tooth 38 is defined as the outer diameter minus the inner diameter divided by two. The height for the variation of FIGS. 22-28 is approximately 0.10-1.00 millimeters in length. The load-bearing face 46 is perpendicular to the longitudinal axis. Both the load-bearing face 46 and the ramped face 48 form a triangle-shaped tooth that extends outwardly from the inner diameter and is formed around the cylindrical surface of the shaft. In cross-section, each tooth 38 forms a scalene triangle in which the two sides of the triangle are of unequal length with the ramped face 48 being longer than the load-bearing face 46. The angle between the load-bearing face 46 and the ramped face 48 is approximately 60 degrees. In another variation the angle between the load-bearing face 46 and the ramped face 48 is between zero degrees and approximately 60 degrees. In another variation, the angle between the load-bearing face 46 and longitudinal axis is between 0 and 90 degrees.

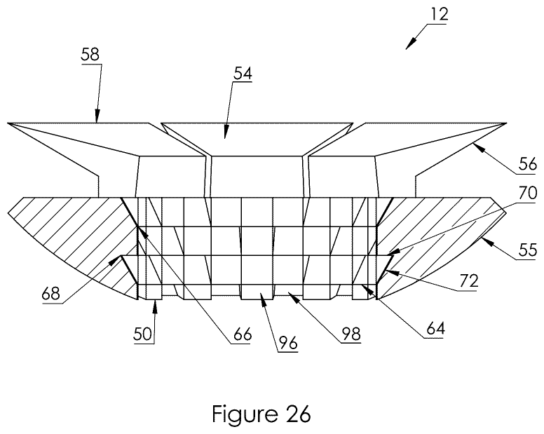

With particular reference to FIGS. 24, 27 and 28, the nut 12 includes ridges 64 that are sized and configured to complementarily engage and interlock with the segmented teeth 38 of the bolt 14. In the variation shown in FIGS. 24, 27 and 28, the ridges 64 are not segmented in a fashion similar to the toothed segments but are circumferential rings around the bore 50 as in the variation of FIGS. 1-17. In another variation, the ridges 64 are segmented to mirror or complement the checkerboard configuration of alternating toothed segments 96 and blank segments 98 around the surface of the bore 50 as shown in FIG. 26. In such a variation, the surface of the bore 50 includes toothed segments 96 that deflect independently against toothed segments 80 on the bolt which also deflect simultaneously in the non-engaged configuration. In yet another variation, the nut 12 is segmented into toothed segments 96 and blank segments 98 as shown in FIG. 26 and the bolt 14 is annularly stepped as in FIG. 3. Having toothed segments 80, 96 on the nut 12 and/or the bolt 14 advantageously permits each segment to deflect more easily because of the adjacent space available for expansion and movement of material into the blank segments as compared with deflecting an entire annular tooth 38 or entirely annular ridge 64.

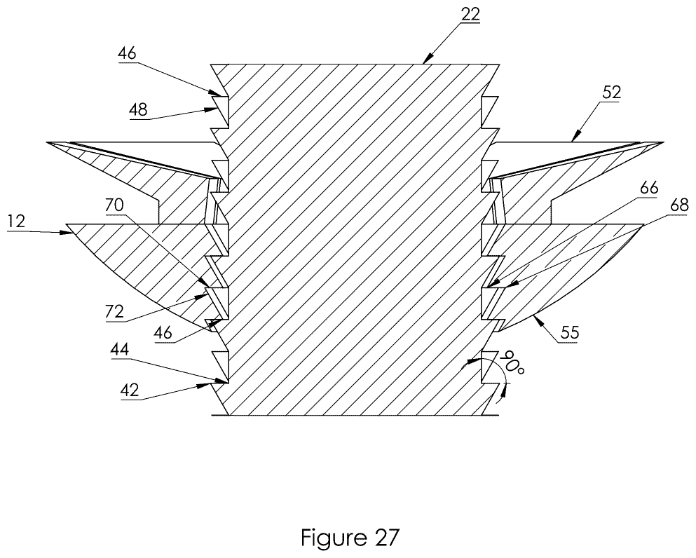

The nut 12 of FIGS. 22-28 is identical to that of FIGS. 1-17. The height of a ridge 64 is defined as the outer diameter minus the inner diameter divided by two. The height is approximately 0.10-1.00 millimeters in length for the variation in FIGS. 22-28. The load-bearing face 70 is perpendicular to the central longitudinal axis. Both the load-bearing face 70 and the ramped face 72 form a triangle-shaped ridge 64 that extends outwardly from the outer diameter of the bore 50 and toward the central longitudinal axis and is formed around the cylindrical surface of the bore 50. In cross-section, each ridge 64 forms a scalene triangle in which the two sides of the triangle are of unequal length with the ramped face 72 being longer than the load-bearing face 70. The angle between the load-bearing face 70 and the ramped face 72 is approximately 60 degrees. In another variation the angle between the load-bearing face 70 and the ramped face 72 is between zero degrees and approximately 60 degrees. In another variation, the angle between the load-bearing face 70 and longitudinal axis is between 0 and 90 degrees. The engaged/locked configuration is shown in FIG. 27 wherein the toothed segments 80 are interlocked with the ridges 64 on the nut 12. The non-engaged/traversing configuration is shown in FIG. 28 wherein the alternating tooth segments 80 on the bolt 14 are simultaneously deflected with ridges 64 on the nut 12 as the tips 42, 66 pass each other.

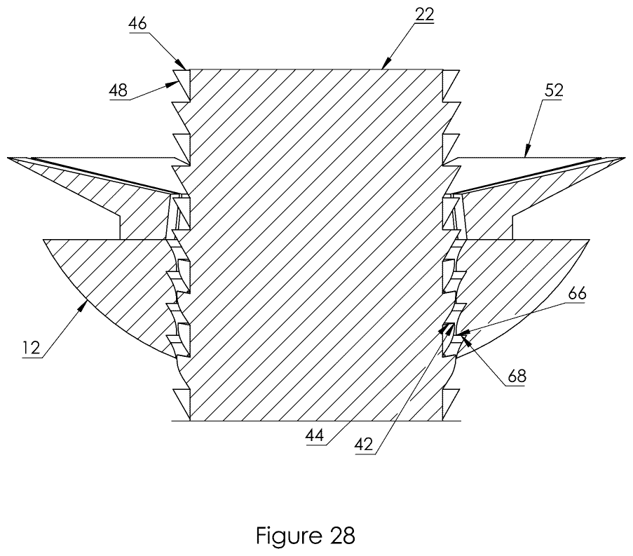

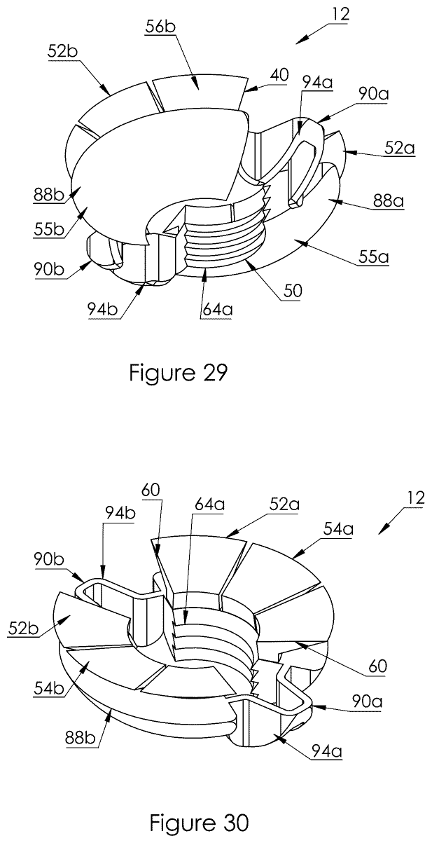

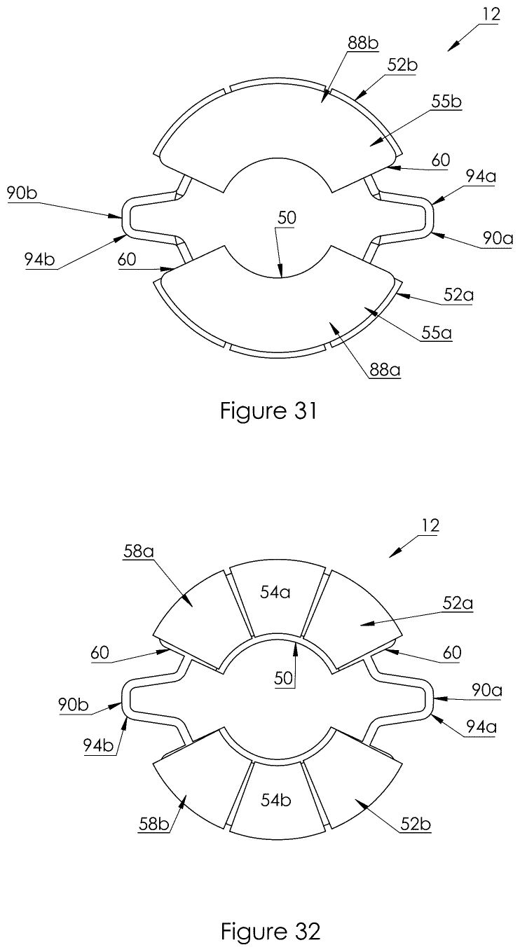

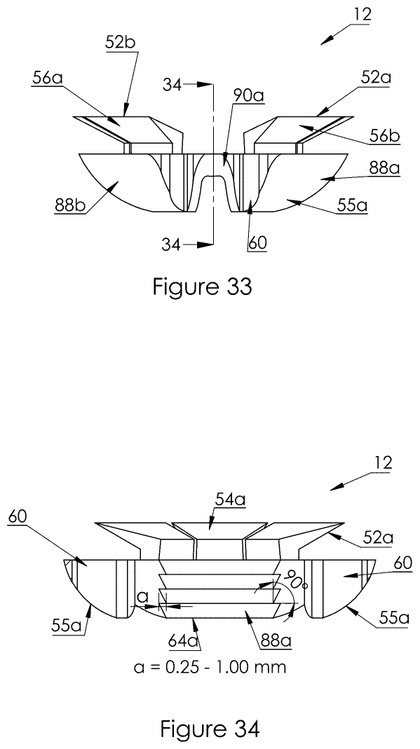

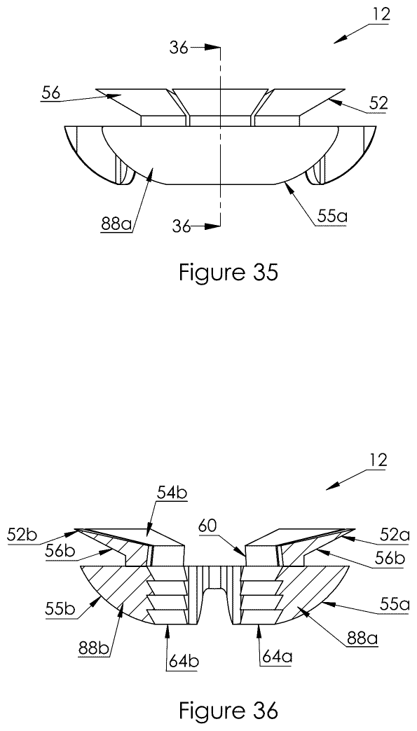

Turning now to FIGS. 29-36, there is shown a variation of the nut 12 according to the present invention wherein like reference numbers are used to describe like parts. The nut 12 can be used with any of the variations of the bolt 14 depicted in FIGS. 1-28 with the nut 12 having ridges 64 sized and configured to match the teeth 28 of a corresponding bolt 14.

Still referencing FIGS. 29-36, the nut 12 includes a central bore 50 extending between a proximal end and a distal end of the nut 12 along the longitudinal axis. The bore 50 is cylindrical in shape and sized and configured to receive the shank 22 of the bolt 14. The nut 12 of FIGS. 29-36 is divided into two oppositely disposed halves. The two halves comprise two oppositely disposed ridged portions 88a, 88b with associated integral washer portions 52a, 52b. The ridged portions 88a, 88b are interconnected by two expandable portions 90a, 90b located between the two ridged portions 88a, 88b.

Each ridged portion 88a, 88b has a half dome-shaped head 55a, 55b. Each ridged portion 88a, 88b includes an associated half of a washer 52a, 52b. The washer halves 52a, 52b are integrally formed with corresponding ridged portions 88a, 88b. The washer 52a, 52b includes an upper surface 54a, 54b and a lower surface 56a, 56b meeting at a tapered outer perimeter. Openings 60 are formed dividing the nut 12 in half. The upper surfaces 54a, 54b and lower surfaces 56a, 56b are angled upwardly and together create a truncated conical upper surfaces 54a, 54b as described above. The upper surfaces 54a, 54b are slightly conical, concave, angled, curved, cone-shaped, spherical, domed or cupped and function together as a spring washer or conical washer which advantageously provides an axial force when deformed under compression. The conical shell of the washer 52a, 52b can be loaded in the longitudinal direction and the force transmission is generally concentric. In one variation, the washer halves 52a, 52b of the present invention are provided with a plurality of radial serrations dividing the washer 52a, 52b into segments or wings 58a, 58b. The wings 58a, 58b are configured to flex, deflect, bend, deform independently and provide a spring force in the opposite axial direction against a fastened object to improve the locking capabilities of the fastener 10 against the object. Unless plastically deformed, the washer 52a, 52b will return to its original undeflected configuration. The individual wings 58a, 58b can deflect independently and, thereby, the upper surface 54a, 54b can more closely conform to a non-smooth, irregular surface of a fastened object.

The internal surface of the bore 50 of the nut 12 is provided with a plurality of ridges 64 formed along the length of the bore 50. The ridges 64a, 64b are sized and configured to conform and mate with the teeth 38 formed on the shank 22 in an interlocking manner. Each ridge 64a, 64b is formed partially circumferentially around the bore 50 at a constant distance along the longitudinal axis of the nut 12. The bore 50 is not threaded as there is no helical shape formed by the ridges 64a, 64b. As previously mentioned, since there are no helical threads formed inside the nut 12, the lead is zero, that is, a revolution of the nut 12 of the present invention with respect to the bolt 14 around the longitudinal axis does not translate the nut 12 along the longitudinal axis. As such, each ridge 64 is a separate semi-circular or partially circular, partially annular, non-helical groove. A plurality of evenly distributed grooves is formed along the length of the bore 50 with each groove lying in separate parallel planes all of which are perpendicular to the longitudinal axis wherein the distance between adjacent parallel planes is called the pitch in the present invention. There are approximately 20-120 teeth per inch along the longitudinal axis. The length of the nut 12 and the number of ridges 64 is configured to provide sufficient locking strength to the nut 12. A greater number of ridges 64 on a nut 12 will provide greater locking strength between the nut and the bolt and the nut will be able to withstand larger axial loads. Also, a greater number of ridges along a correspondingly longer nut, will require greater force to move the nut along the bolt. Hence, the number of ridges 64 in the nut and the corresponding length of the nut is selected for a given application as needed to withstand the required amount of axial load in the distal direction to lock the nut with the nut still being movable on the bolt in the proximal direction without undue force. In one variation, there are approximately 4-6 ridges 64 in a nut 12. In another variation, there are at least 4 ridges 64. In another variation, there are 4-10 ridges 64 and, in another variation, there are at least 3 ridges. The configuration of the ridges 64 can be of any of the previous configurations described above wherein the triangular shape of the ridges 64 correspond to the triangular shape of the teeth 38 in order to interlock with each other as described in any of the variations above with respect to FIGS. 1-28.

The expandable portions 90a, 90b are configured to flex and to expand when depressed inwardly toward the central longitudinal axis. Expansion of the expandable portions 90a, 90b will move the oppositely disposed ridged portions 88 outwardly to release the ridges 64a, 64b from engagement with teeth 38 on the bolt 14. Thereby, this expandable nut 12 can be easily removed by sliding the nut 12 along the bolt 14 in either direction while the expandable portions 90a, 90b are compressed inwardly without having to cut bolt 14 to release the fastener 10 as described above. The nut 12 and bolt 14 remains unidirectional as the nut 12 is permitted only to slide on one direction towards the head 20 of the bolt 14 when the teeth 38 and ridges 64 are engaged in an engaged configuration. When the expandable portions 90a, 90b are depressed, the ridged portions 88a, 88b are configured to move radially outwardly by a sufficient distance to disengage the ridges 64a, 64b from the teeth 38 and permit removal of the nut 12. Each expandable portion 90a, 90b includes a U-shaped protrusion 94a, 94b forming a living hinge with the open end of the U-shape facing the bore 50. When the U-shaped protrusion is depressed with a finger or instrument, the U-shape will elongate and flatten moving the ridged portions 88a, 88b radially outwardly to disengage the ridged portions 88a, 88b from the bolt 14. Both expandable portions 90a, 90b are simultaneously compressed from opposite directions to increase the diameter of the bore 50. The expandable portions 88a, 88b can be compressed for removal of the nut 12 or for locating the nut 12 on the bolt 14. Furthermore, because the nut 12 is expandable, the nut 12 will expand by the force created when sliding over the teeth 38 on the bolt 14 similar to a rack-and-pawl. When in a non-engaged configuration, the teeth 38 and ridges 64 do not deflect or deflect less because the nut expands slightly outwardly as ridges 64 ramp over the teeth 38 when the nut 12 slides with respect to the bolt 14. Just sliding the nut with respect to the bolt provides sufficient force to expand the hinge and, thereby, increase the bore diameter. The hinged expandable portion 88a, 88b will then snap back or return to its original unexpanded or less expanded configuration/diameter when the ridges 64 are interlocked between the teeth 38. As such, the nut 12 advantageously slides smoothly along the bolt and the expandable portions need not be compressed to locate the nut on the bolt.

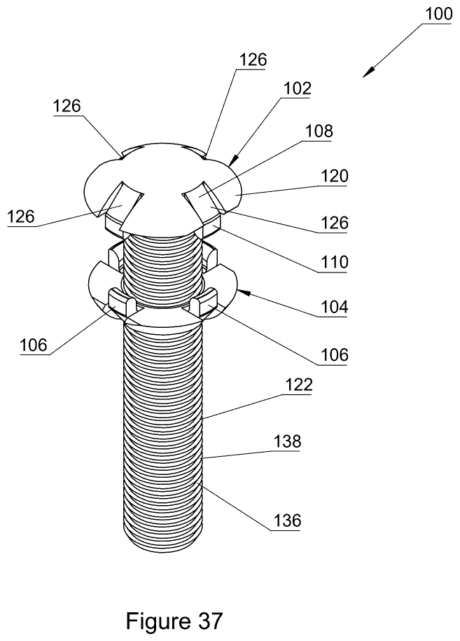

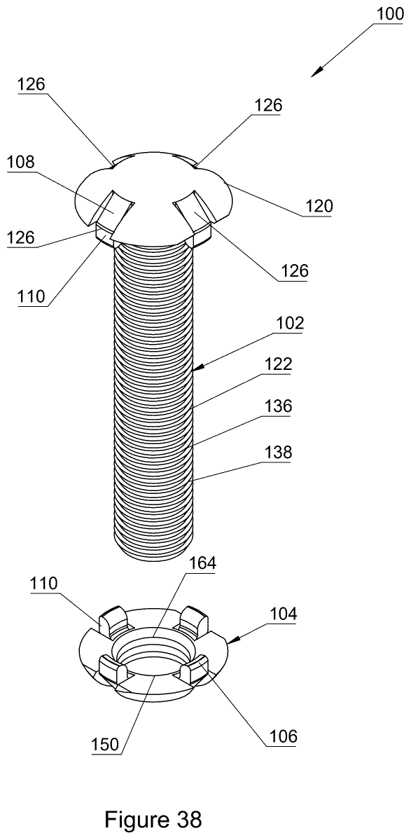

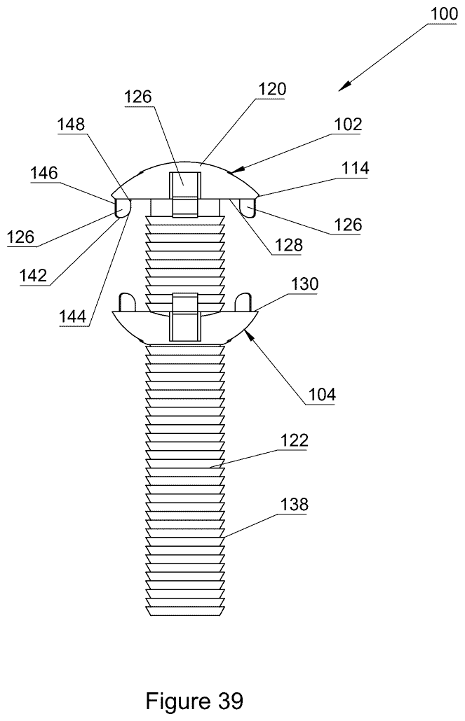

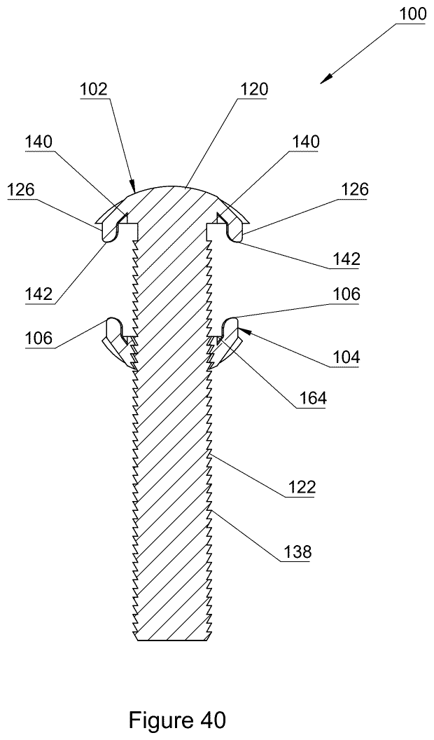

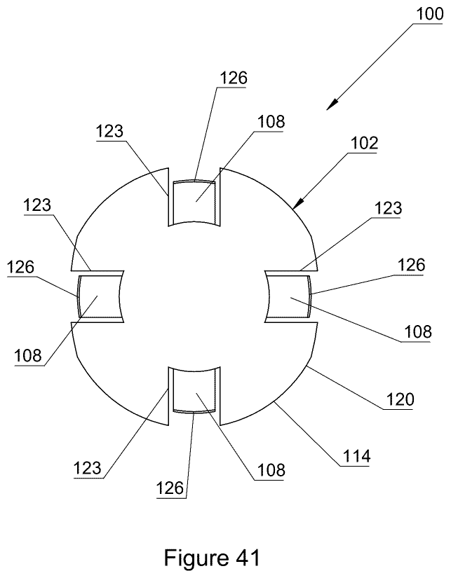

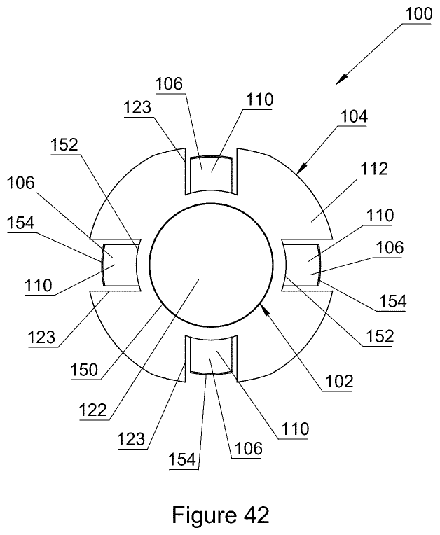

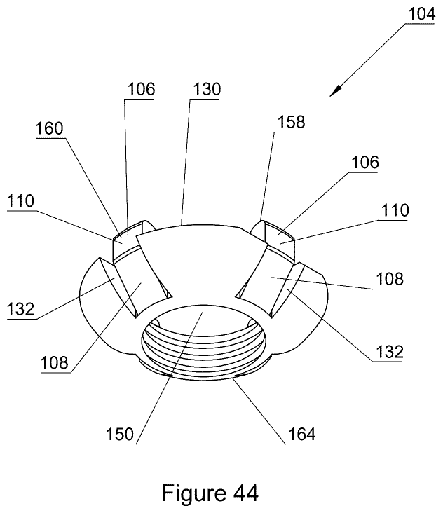

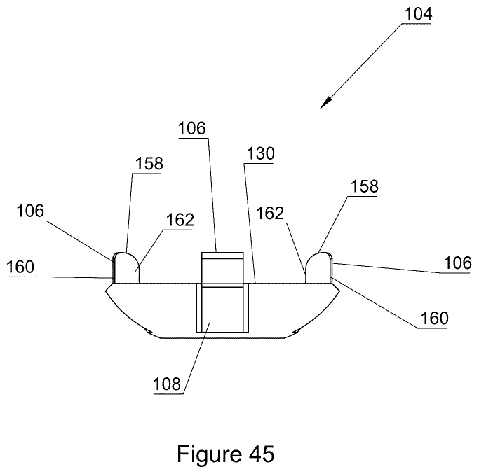

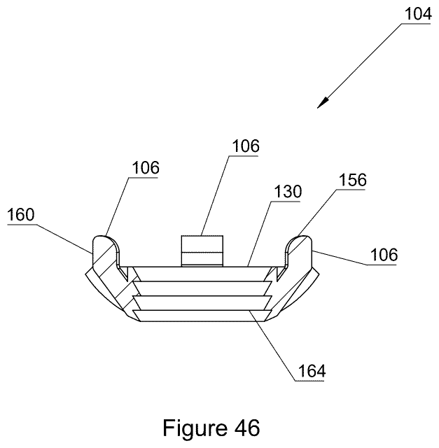

FIGS. 37-50 depict a fastener 100 according to another variation of the invention. The fastener 100 comprises a first part connectable to a second part and configured to fasten together one or more objects therebetween. The first part and the second part of the fastener 100 take the form of a bolt 102 and a nut 104. The bolt 102 comprises an elongate body extending between a proximal end and a distal end along a central longitudinal axis. The elongate body is divided into two sections: a head 120 at the proximal end connected to a cylindrical shank 122 extending to the distal end.

The head 120 at the proximal end defines a workable end that is adapted to be worked or gripped by a hand, power tool or robot for handling and manipulating the bolt 104. The head 120 has a diameter larger than the diameter of the shank 122. The larger diameter of the head 120 provides a proximal gripping surface and thereby prevents the fastener 100 from translating distally through a workpiece. The head 120 has a domed top surface and a flat undersurface 128 meeting at a tapered perimeter 114. The head 120 is circular in shape. In another variation, the head 120 is elongated or elliptical in shape. In one variation, the domed surface of the head 120 does not have any socket or outer surface configured for engaging an instrument to drive the bolt 104.

The head 120 includes at least one spring tensioner 126 integrally formed with the head 120 as a unitary element. The variation of the fastener 100 shown in FIGS. 37-50 includes four spring tensioners 126; however, any suitable number of spring tensioners 126 is within the scope of the invention. The four spring tensioners 126 shown in the figures are oppositely located from each other and divide the flat undersurface 128 of the head 120 into four sections. Each spring tensioner 126 is cantilevered at a proximal end 140 and extends from the proximal end 140 to a free distal end 142. The proximal end 140 is integrally connected to the head 120. The spring tensioners 126 will be described in greater detail below.

The shank 122 now will be described in greater detail. The shank or shaft 122 includes a toothed portion 136 having a plurality of teeth 138 along the length of the shank 122. The shank 122 may have any arrangement of teeth 138 including but not limited to the arrangement of teeth 38, toothed segments 80 and/or blank segments 82 as described above with respect to FIGS. 1-36. For example, each tooth 138 may be formed circumferentially around the shank 122 at a constant distance along the longitudinal axis. In another example, the toothed portion 136 includes toothed segments 80 and blank segments 82 as described above with respect to FIGS. 22-36. In these examples, the toothed portion 136 is not threaded as there is no helical shape formed in the teeth. However, the invention is not so limited and the spring tensioners 126 of the head 120 may also be employed with shanks 122 having helical threads. In one variation, the shank 122 is cylindrical; however, the invention is not so limited, and the body portion may include flat surfaces or have a non-circular cross-sectional shape for non-helically threaded embodiments.

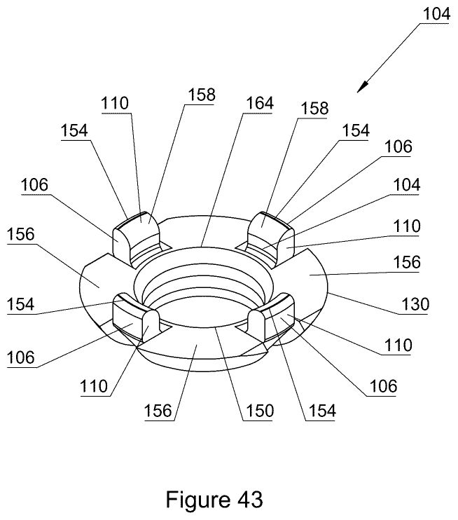

With particular reference to FIGS. 43-46, the nut 104 according to the present invention will be discussed. The nut 104 includes a central bore 150 extending along the longitudinal axis forming an annular shape having an outer perimeter 130. The bore 150 is cylindrical in shape and sized and configured to receive the shank 122 of the bolt 102. The internal surface of the bore 150 of the nut 104 is provided with a plurality of teeth 164 formed along the length of the bore 150. The teeth 164 are sized and configured to conform and mate with the teeth 138 formed on the shank 122 in an interlocking manner as described with respect to the nut in FIGs. Each tooth 164 is formed circumferentially around the bore 150 at a constant distance along the longitudinal axis of the nut 104 such that the bore 150 is not threaded as there is no helical shape formed by the teeth 138. Since there are no helical threads formed inside the nut 104, the lead is zero, that is, a revolution of the nut 104 with respect to the bolt 102 around the longitudinal axis does not translate the nut 104 along the longitudinal axis. As such, each tooth 164 is a separate circular, annular, non-helical groove, step or ring interconnected with itself around the inside surface of the bore 150. A plurality of equally spaced grooves or steps is formed along the length of the bore 150 with each groove lying in separate parallel planes all of which are perpendicular and concentric to the longitudinal axis wherein the distance between adjacent parallel planes is called the pitch in the present invention. There are approximately 20-120 teeth per inch along the longitudinal axis. The length of the nut 104 and the number of teeth 164 is configured to provide sufficient locking strength to the nut 104. A greater number of teeth 164 on a nut 104 will provide greater locking strength between the nut and the bolt and the nut will be able to withstand larger axial loads. Also, a greater number of teeth along a correspondingly longer nut, will require greater force to move the nut along the bolt. Hence, the number of teeth in the nut and the corresponding length of the nut is selected for a given application as needed to withstand the required amount of axial load in the distal direction to lock the nut with the nut still being movable on the bolt in the proximal direction toward the head 120 of the bolt 102 without undue force. In one variation, there are approximately 4-6 teeth 164 in a nut 104. In another variation, there are at least 4 teeth 164. In another variation, there are 4-10 teeth 164 and, in another variation, there are at least 3 teeth 164. The nut 104 may have any arrangement of teeth 164 including but not limited to the arrangement of ridges 64, toothed segments 96 and/or blank segments 98 as described above with respect to FIGS. 1-36. In another variation, the teeth 164 on the nut 103 are helically arranged to correspond with the variation of a bolt 102 having corresponding helical teeth 138.

The nut 104 includes at least one spring tensioner 106 integrally formed with the nut 104 as a unitary element. The variation of the fastener 100 shown in FIGS. 37-50 includes four spring tensioners 106 on the nut 104; however, any suitable number of spring tensioners 106 is within the scope of the invention. The four spring tensioners 106 shown in the figures are oppositely located from each other. Each spring tensioner 106 is cantilevered at a proximal end 152 and extends from the proximal end 152 to a free distal end 154. The proximal end is integrally connected to the body of nut 106 and divide a flat undersurface 156 of the nut 104 into four sections. The spring tensioners 106 on the nut 104 are identical to the spring tensioners 126 on the head 120 of the bolt 102. The spring tensioners 106 on the nut 104 extend upwardly towards the head 120 of the bolt 102 when the nut 104 is passed onto the shank 122 and the spring tensioners 126 on the bolt 102 extend downwardly away from the head 120 and toward the nut 104 as shown in FIG. 37, for example. The spring tensioners 106 on the nut 104 may be formed by radial cuts extending from the perimeter 130 of the nut towards the bore 150. The cuts free the spring tensioners 106 making them deflectably movable with respect to the nut 104 and form channels 132 within which the spring tensioners 106 may be deflected into and recessed. Similarly, the spring tensioners 126 on the head 120 may be formed by cuts extending from the perimeter 114 of the head 120 towards the shaft 122. The cuts free the spring tensioners 126 on the head 120 making them deflectably movable with respect to the head and form channels 123 within which the spring tensioners 126 may be deflected into and recessed such that both the nut and the head of the fastener are flush with the surface of a workpiece(s) upon tensioning of the spring tensioners.

Each of the spring tensioners 106, 126 includes a proximal end 140, 152 integrally connected to the bolt 102, nut 104, respectively, and a free distal end 142, 154 extending beyond a flat undersurface 128, 156 of the head 120, nut 104, respectively, along the longitudinal direction when in a relaxed, unstressed and undeflected state. The spring tensioners 106, 126 are configured to flex with respect to the head 120, nut 104, respectively and splay laterally outwardly away from the longitudinal axis. Each spring tensioner 106, 126 includes a first portion or leg 108 connected to a second portion or foot 110. The leg portion 108 is connected to the bolt 102, nut 104 at a proximal end 140, 152 and is angled away from the longitudinal axis. The foot portion 110 is connected to the distal end of the leg portion 108. The foot portion 110 extends downwardly parallel to the longitudinal axis and includes a distal end 142, 154 having a rounded surface 144, 158 facing the longitudinal axis to reduce friction when in contact with workpiece members. The rounded surface 144, 158 is interconnected with a flat outer surface 146, 160 and a flat inner surface 148, 162 of the spring tensioner 126, 106 of the bolt 102 and nut 104, respectively.

The bolt 102 is sized and configured to fit inside the bore 150 of the nut 104 with interference between the circumferential teeth 138 on the bolt 102 and the circumferential teeth 164 on the surface of the bore 150 of the nut 104. As such, the inner diameter of the bore 150 is larger than the inner diameter of the shank 122. Also, the inner diameter of the bore 150 is smaller than the outer diameter of shank 122. The outer diameter of the bore 150 is larger than the outer diameter of the shank 122. The interference between the teeth 164 on the bore 150 and the teeth 138 on the shank 122 is configured such that the teeth 138, 164 interlock to fix the longitudinal position of the nut 104 relative to the bolt 102. The fastener system defines an engaged configuration in which the teeth 138, 164 are interlocked. In particular, a load-bearing face of the teeth 138 abut, contact, face, and are substantially parallel to a load-bearing face of the teeth 164 and translation of the nut 104 relative to bolt 102 in a distal direction away from the head 120 of the bolt 102 is arrested. In this engaged configuration, one or more of the teeth 164 of the nut 104 are engaged/interlocked with an equal number of teeth 138 on the bolt 102 If the entire nut 104 is located proximal to the distal end of the bolt 102, all of the ridges 164 are interlocked, engaged with an equal number of teeth 138 on the bolt 102. When in the engaged configuration, movement of the nut 104 relative to the bolt 102 in a distal direction is prevented by the abutment of the load-bearing faces however, translation of the nut 104 relative to the bolt 102 in a proximal direction toward the head 20 is permitted as the ramped surfaces are permitted to slide relative to each other due to their moderate slope, angle. Hence, the fastener 100 of this variation is a unidirectional fastener, permitting translation of the nut 104 relative to the bolt 102 in only one direction, that being in the proximal direction toward the head 120 of the bolt 102 in order to reduce the distance between the nut 104 and the head 120 of the bolt 102 and fasten against an object captured therebetween. The unidirectional fastener does not permit translation of the nut 104 relative to the bolt 102 distally toward the distal end of the bolt. In a variation with a helically threaded nut and bolt, the rotational movement in a clockwise or a counterclockwise direction of one of the nut/bolt with respect to the other causes relative translation along the longitudinal direction.

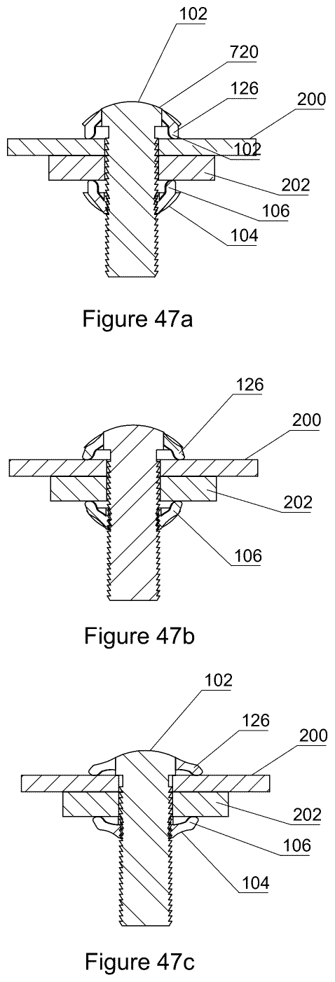

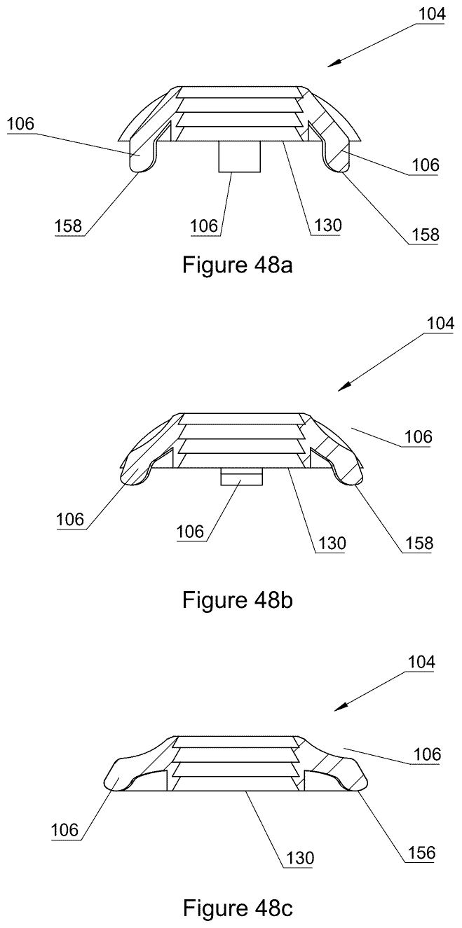

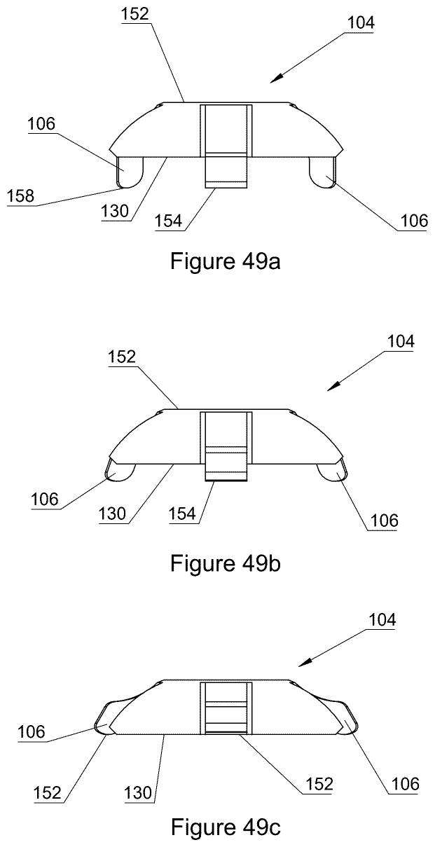

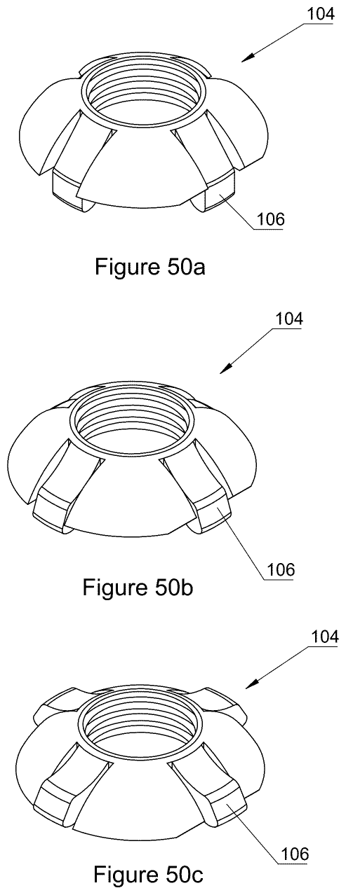

With reference to FIGS. 47-50, in use, the bolt 102 is passed through apertured workpiece members 200, 202 such that the head 120 is adjacent to the first apertured workpiece member 200. The nut 104 located adjacent to the second apertured workpiece member 202 in the proper orientation with the spring tensioners 106 facing the second apertured workpiece member 202 on a side of the workpiece members 200, 202 opposite from the head 120. The bore 150 of the nut 104 is passed onto the shank 122 of the bolt 102. The nut 104 is moved relative to the bolt 102 in a direction towards the head 20 of the bolt 14. Movement of the nut 104 continues and the distal ends 142, 154 of the spring tensioners 126, 106 of the bolt 102 and nut 14 contact the first and second apertured workpiece members 200, 202 as shown in FIG. 47A. FIGS. 48A, 49A and 50A show different views of an undeflected configuration of the spring tensioners 106 of the nut 104. The same figures may be representative of the spring tensioners 126 on the head 120 of the bolt 102. The distance J along the longitudinal axis from the distal end 152 of the spring tensioners 106 to the end of the nut 104 is the undeflected length of the spring tensioners 102 along the longitudinal axis with the workpiece members 200, 200 in contact with each other and in contact with the spring tensioners 126, 106 of the bolt 102 and nut 104. The nut 104 will be moved further relative to the bolt 102 to reduce the distance between the flat undersurface of the bolt 128 and the flat undersurface of the nut 156. The rounded surface 144 of the spring tensioners 126 of the bolt 102 will slide along the first workpiece member 200 and the rounded surface 158 of the spring tensioners 106 of the nut 104 will slide along the second workpiece member 202 as the spring tensioners 106, 126 splay outwardly away from the longitudinal axis and are deflected into channels 132, 123 in the nut 104 and bolt 102 in a partial deflected state shown in FIGS. 47B-50B wherein the distance K between the proximal end 152 and distal end 154 of the spring tensioner 106 is less than the distance J. As the nut 104 is further advanced along the shank 122, the spring tensioners 126, 106 continue to deflect and splay outwardly away from the longitudinal axis until the flat undersurface 128 of the bolt 104 contacts the first workpiece member 202 and the flat undersurface 156 of the nut 102 contacts the second workpiece member 202 as shown in FIG. 47C resulting a completely deflected or fully recessed configuration of the spring tensioners 106, 126 such that the spring tensioners 106, 126 are completely recessed within their respective channels 132, 123. In this configuration, the distance L along the longitudinal axis is equal to the height of the nut 104 along the longitudinal axis as shown in FIG. 49C. Other views of this configuration of the nut 104 are shown in FIGS. 48C and 50C. The distal ends 142, 154 of the spring tensioners 126, 106 remain in contact with the workpiece members 200, 202. The spring tensioners 106, 126 may flex independently of each other and conform against an irregular surface. With continued compression of workpiece members 200, 202, a spring force in the opposite axial direction will be exerted thereby increasing the friction against the load-bearing surfaces of the teeth/threads locking the nut 104 tightly to the bolt 102 and against the workpiece members 200, 202. Successive stages of installation into the apertures of workpiece comprising workpiece members 200, 202 may include using an installation tool to secure the workpiece members and bias the nut and bolt towards each other. The bolt 104 may be inserted by the operator by hand into the apertures of the workpiece members 200, 202 until the spring tensioners 126 contact the outer surface of the first workpiece member 200. At this stage, part of the shank 122 protrudes from the second workpiece member 202. The nut 104 is then fitted onto the protruding end of the shank 122 using an installation tool. Alternatively, the nut 104 may be fitted onto the protruding end of the shank 122 by hand without an installation tool. In such case, the shank 122 is formed with a threadless/toothless distal portion so that the nut 104 may be easily located on a unidirectional non-helical variation or threaded helical variation of the bolt/nut. Of course, in a threaded configuration a threadless distal portion of the shank 122 may not be necessary and the nut 104 may be rotatably threaded onto the distal end of the shank 122 to locate the nut 104 on the bolt 102 in preparation for the next stage of installation which may include the use of an installation tool. The installation tool may include a retention feature to hold one of the bolt/nut and a plunger to push the other one of the bolt/nut towards each other. The retention feature of the installation tool may operate to clamp a pintail feature having a groove formed on the distal end of shank 122 while the plunger pushes the nut 104 relatively along the shank 122 towards the head 120. For example, upon actuation of the installation tool, a hydraulic piston exerts an increasing pulling force on a collet, thereby pulling the collet into the tool and thereby exerting a pulling force on the pintail via the pintail pull groove. As the collet is pulled into the tool, the pulling force is transferred to the pintail via the pull groove. Therefore, the pintail is also pulled in towards the tool. As the pintail is pulled in, the nut comes into contact with an anvil portion and the nut is progressively pushed by the anvil in the direction of the head 120 of the bolt 102. The workpiece members 200, 202 are thereby pushed together, closing any gap between them. As the force applied increases, the retention members are deflected to further increase the friction holding force to secure the workpiece members together. A force meter on the installation tool may provide the user with an indication of the degree of deflection of the spring tensioners and be set as desired.

In the nut-and-bolt fastener, the spring tensioners are integrated into both the head of the bolt and the nut. Of course, the spring tensioners may be integrated into at least one of the head of the bolt and the nut. As the nut is secured tightly onto the bolt, the four tensioners on each component are pressed into their final flush position with respect to the bodies of the nut and the bolt. This action moves them from a low energy position to a high energy position where they store potential energy. This energy is translated into an opposing spring force with respect to both the material being fastened and each other. Such force acts to preload the system and prevent the loosening of the fastening system in two principal ways. In a traditional helically threaded nut and bolt fastener, the tensioners apply a stretching force along the bolt shaft that deforms the bolt threads and, thereby, locks the nut and bolt together. In a traditionally helically threaded nut and bolt fastening system, tightening the nut onto the bolt stretches the bolt and shaft to increase friction. As a result, this helps to lock the system; however, stretching the bolt does not ensure that the nut will not translate back down distally on the threads thereby loosening the nut from the bolt. In a non-helical configuration, there is no need to deform the bolt shaft and threads in order to hold the system tight once fastened. This advantageously confers greater strength. Moreover, stretching and deforming the bolt and threads causes fatigue making them prone to failure. In a non-helically threaded nut and bolt fastener described herein, the tensioners apply opposing force against the ratchets that are integrated around the outer circumference of the bolt and inside the inner circumference of the nut. This force presses the ratchets from the deflected position back into the undeflected and fully engaged position, thereby preventing distal translation of the nut.

Advantageously, the buttressed spring tensioners obviate the necessity for lock washers, castle nuts, cotter pins, locking adhesives, adhesive tapes, nylon inserts, clips, retainers, tension or jam nuts and other devices that required to prevent nuts from vibrating loose in traditional helically threaded systems. Advantageously, the spring tensioning arms of the present invention press up flush with the bolt head and nut undersurface, thereby presenting a flatter, more streamlined profile for the parts of the fastening system that protrude beyond the materials being assembled. Also, the integral spring tensioning system can be employed advantageously on both helically and non-helically (annularly) threaded nut and bolt fasteners. Increased bearing force may be applied via the spring tensioners described herein and the spring tensioning system is advantageously easier to manufacture. Also, because the spring tensioners advantageously can adjust with changes in the workpiece, the fastener will remain tight as the spring tensioners adapt to changes in the workpiece such as when workpiece(s) compress, partially ablate, erode, disintegrate, abrade, wear down, deteriorate and the like.

The fasteners disclosed herein can be used wherever items are conventionally affixed by standard nuts and bolts. The fastener has broad applicability and can be employed in a variety of commercial applications and various scale sizes. The fastener of the present invention can reduce manufacturing costs of many consumer items, especially items that are not intended for repair and re-assembly. The consumer items are not limited to consumer electronics, digital cameras, wireless headphones, video gaming accessories and a variety of other items that are assembled by hand or machine in factories. Many types of retail consumer products are currently manufactured with fasteners that require time and energy to assemble. These products will come apart when the fasteners loosen or fail. The fastener of the present invention can replace helically threaded fasteners in a variety of construction applications where the parts are expected to remain joined for lengthy periods of time without re-torqueing. Some examples are beam and joist connections, electrical and plumbing systems, snap-together flooring, earthquake retrofitting, furniture, appliance footings, bridges, road signage and street lighting. Additionally, fasteners according to the present invention possess unique advantages in mechanical applications where rotation of armatures will cause helically threaded fasteners to vibrate loose and fail. These include but are not limited to motors and other machinery, robotic parts, and drive/suspension parts in cars, trucks, ships, helicopters, drones, airplanes, missiles and rockets. The fastener of the present invention can also serve as a rapid on-site retrofit repair for existing nuts and bolts that have failed. Other use-cases exist for the present invention in medical applications such as biocompatible stable bone fixation, orthopedics, plumbing, hose clamps, law enforcement, disposable single-use handcuffs, flat-pack shipping for easy and rapid assembly by the consumer, toys, snap-together models, cargo container inspection locks, emergency snap-together life rafts and shelters and aerospace applications where the fastener's light weight and easy push-fastening make it superior to torqueing bolts in extreme environments such undersea and/or weightless conditions such as outer space. Additionally, because there are no slots or indentations in the bolt head for engagement with a driving instrument, the surface of the head is smooth. Therefore, the fastener system of the present invention is tamper resistant making the system particularly applicable in safety and security applications. Also, the lack of a driver socket in the head permits the head to have a low profile along the vertical longitudinal axis such that it protrudes less above the workpiece surface than a head that would require an insertion socket for a driver instrument.

The present invention overcomes the numerous disadvantages of conventional helically threaded nut-and-bolt fasteners. In particular, rotational force is not required to thread the nut onto the bolt, thereby, providing energy savings and simple and quick push-to-fasten assembly. The present invention avoids the need for specific tools, wrenches, screwdrivers and the like. In contrast, a host of different tools are required to attend to different types of conventional nut-and-bolt fasteners. Furthermore, rotational torque is not required and associated problems with under-torquing and over-torquing are avoided by the fastener of the present invention. Furthermore, bolts of different lengths are not required for different applications because cutting a bolt of the present invention to an appropriate length is easily accomplished. There is no problem of cross-threading with the present invention that would damage and waste fasteners. Other damage to a conventional bolt and thread may arise from clamping the threads in which case would prevent a nut being removed from or placed on a bolt. In contrast, if some of the ridges or teeth of the present invention are damaged, the bolt and nut can advantageously still be fastened by engaging the non-damaged ridges and teeth or easily unfastened in ways described above. Also, the push-to-fasten fastener of the present invention can be easily employed in small spaces because leverage is not required to apply torque. Importantly, the fastener of the present invention will not lose preload and loosen with time, vibration or rotation and, hence, the failure rate of the present invention will be much less than conventional nuts-and-bolts preventing accidents, saving money and lives.

It is understood that various modifications may be made to the embodiments of the fastener disclosed herein. Therefore, the above description should not be construed as limiting, but merely as exemplifications of preferred embodiments. Those skilled in the art will envision other modifications within the scope and spirit of the present disclosure.

I claim:

1. A fastener, comprising:
a bolt having a head at a proximal end and a shaft extending from an undersurface of the head to a distal end along a central longitudinal axis; the head having a diameter larger than the shaft; the head including at least one deflectable spring tensioner integrally formed with the head and extending a distance beyond the undersurface toward the distal end when in an undeflected configuration; and
a nut defining a cylindrical bore extending through the nut along the longitudinal axis from a proximal end to a distal end of the nut; the bore and shaft being sized and configured such that the shaft is frictionally engaged within the bore and movable relative to the nut along the longitudinal axis; the nut including at least one deflectable spring tensioner integrally formed with the nut and extending a distance beyond an undersurface of the nut when in an undeflected configuration;
wherein the spring tensioner on the head is configured to deflect away from the longitudinal axis towards a proximal end when in deflected configuration so as to reduce the distance the spring tensioner extends beyond the undersurface of the head; and
wherein the spring tensioner on the nut is configured to deflect away from the longitudinal axis so as to reduce the distance the spring tensioner extends beyond the undersurface of the nut.

2. The fastener of claim 1 wherein the shaft and bore have matingly-engageable helical threads such that the shaft is relatively movable inside the bore along the longitudinal axis in both directions.

3. The fastener of claim 1 wherein the shaft and bore having matingly-engageable, non-helical, uniformly-spaced circumferential rings around the shaft such that the nut is relatively movable on the shaft along the longitudinal axis in one direction towards the head.

4. The fastener of claim 1 wherein the undersurface of the head and the undersurface of the nut are flat and lie in planes perpendicular to the longitudinal axis.

5. The fastener of claim 1 wherein the spring tensioner on the head and the spring tensioner on the nut each have a rounded distal end.

6. The fastener of claim 1 wherein the spring tensioner on the head and the spring tensioner on the nut are biased to spring back from the deflected configuration to the undeflected configuration.

7. The fastener of claim 1 wherein the spring tensioner on the head is integrally formed with the head and the spring tensioner on the nut is integrally formed with the nut.

8. The fastener of claim 1 wherein the spring tensioner on the head is deflectable such that the spring tensioner does not extend beyond and is flush with the undersurface of the head, and the spring tensioner on the nut is deflectable such that the spring tensioner does not extend beyond and is flush with the undersurface of the nut.

9. The fastener of claim 1 wherein the fastener is configured to fasten at least one workpiece between the head and the nut; wherein relative movement of the head towards the nut deflects one or more of the spring tensioners on the head or nut.

10. The fastener of claim 1 wherein the spring tensioner on the head is cantilevered to the head at a location proximal to the undersurface of the head; and the spring tensioner on the nut is cantilevered to the nut at a location proximal to the undersurface of the nut.

11. The fastener of claim 1 wherein the spring tensioner on the head is deflectable into a channel formed in the head and the spring tensioner on the nut is deflectable into a channel formed in the nut.

12. The fastener of claim 1 wherein the head includes four equally-spaced spring tensioners and the nut includes four equally-space spring tensioners.

13. The fastener of claim 1 wherein the head does not have a socket for inserting a driver instrument.

14. A fastener, comprising:
a bolt having a head at a proximal end and a shaft extending from an undersurface of the head to a distal end along a central longitudinal axis; the head having a diameter larger than the shaft; and
a nut defining a cylindrical bore extending through the nut along the longitudinal axis from a proximal end to a distal end of the nut; the bore and shaft being sized and configured such that the shaft is frictionally engaged within the bore and movable relative to the nut along the longitudinal axis;
wherein at least one of the head and the nut including at least one integrally formed deflectable spring tensioner;
wherein the at least one spring tensioner is configured to contact a surface of one or more workpiece being fastened between the head and the nut when in an undeflected configuration and to flex against the workpiece surface into a deflected configuration away from the longitudinal axis when a longitudinal distance between nut and the head is reduced from the undeflected configuration.

15. The fastener of claim 14 wherein the at least one spring tensioner is resilient and biased to spring back into an undeflected configuration.

16. The fastener of claim 14 wherein when in a deflected configuration the at least one spring tensioner is configured to flex toward or away from the longitudinal axis to adaptively conform to a variation in thickness of the one or more workpiece.

17. The fastener of claim 14 wherein the at least one spring tensioner is configured to exert a force along the longitudinal axis against the one or more workpiece when in a deflected configuration.

18. The fastener of claim 14 wherein the nut is configured to rotate relative to the bolt when in a deflected configuration.
